(19) United States
(12) Patent Application Publication
(10) Pub. No.: US 2015/0167995 A1
(43) Pub. Date: Jun. 18, 2015

(54) SAFE SANDBOX MODE FOR A HOME DEVICE

(71) Applicant: Google Inc., Mountain View, CA (US)

(72) Inventors: Anthony M. Fadell, San Francisco, CA (US); Matthew L. Rogers, Los Gatos, CA (US); David Sloo, Menlo Park, CA (US)

(21) Appl. No.: 14/563,752

(22) Filed: Dec. 8, 2014

Related U.S. Application Data
(60) Provisional application No. 61/915,391, filed on Dec. 12, 2013.

(51) Int. Cl. F24F 11/00; G05B 15/02

(52) U.S. Cl. CPC F24F 11/006; G05B 15/02

(57) ABSTRACT

A system configured to control a heating, ventilation, or air conditioning (HVAC) system may include an electronic device having a user input interface configured to receive a guest input from a guest user, the guest input including identifying information relating to the guest user. The electronic device may also include a processor configured to determine a level of access of the guest user based on the identifying information and on an input from a primary user. The level of access of the guest user may determine the guest user's ability to adjust a setting of the HVAC system via the electronic device. The processor is also configured to initiate a guest mode of operation where the guest user is able to make a setting adjustment to the HVAC system via the electronic device in place of an established setting adjustment schedule of the primary user in accordance with the determined level of access.

### CROSS-REFERENCE TO RELATED APPLICATIONS

This application claims priority to and the benefit of U.S. Provisional Patent Application No. 61/915,391, entitled “Safe Sandbox Mode for a Home Device,” filed on Dec. 12, 2013, which is incorporated by reference herein in its entirety for all purposes.

### BACKGROUND

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

While substantial effort and attention continues toward the development of newer and more sustainable energy supplies, the conservation of energy by increased energy efficiency remains crucial to the world's energy future. Heating and cooling account for a majority of the energy use in a typical U.S. home, making it the largest energy expense for most homes. Along with improvements in the physical plant associated with home heating and cooling (e.g., improved insulation, higher efficiency furnaces), substantial increases in energy efficiency can be achieved by better control and regulation of home heating and cooling equipment.

Programmable thermostats, for example, have become more prevalent in recent years in view of increased efforts to make environmentally-conditioned areas (e.g., homes and offices) more energy efficient. Generally, programmable thermostats can be programmed by a user to activate heating, ventilation, and air conditioning (HVAC) equipment for selected time intervals and at certain operating levels, with the goal of saving energy while simultaneously creating a comfortable environment. A number of different settings for an HVAC system can be individually manipulated to this end. Unfortunately, the number of potential adjustments and inputs available to users is often intimidating and time-consuming Coupled with the array of switches and controls laid out in various configurations on the face of the thermostat or behind a panel door on the thermostat, many users seldom adjust the manufacturer defaults to optimize their own energy usage.

Furthermore, even if a user were to program the thermostat to some extent, the settings chosen by the user may not be appropriate for all situations, for instance when the user has visitors. In addition, other persons not familiar with the programming of the thermostat may manually adjust the thermostat and inadvertently cause inefficient operation of the HVAC system. Thus, even though the installed programmable thermostats in a large number of homes are technologically capable of operating the HVAC equipment with energy-saving profiles, and even though some may be programmed to some extent, users will often manually manipulate the displayed set temperature as if the unit were a simple, non-programmable thermostat.

In addition to the thermostats used to control the HVAC system of a home, users can use a variety of other devices to control other home operations. For example, lights, refrigeration units, fans, and similar devices can also be controlled for lighting, refrigeration, and cooling. Manually operating devices such as these can introduce energy inefficiency in the same manner as heating and cooling a home using a traditional thermostat, or not using a programmable thermostat in the most energy efficient manner. In addition to the usage of excess energy caused by the manual operation of such devices, excess waste may also be produced from more frequent replacement of device parts (e.g., fan motors, light bulbs, and refrigerator compressors). The excess energy usage and additional replacement parts both result in increased costs ultimately shouldered by users.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Embodiments of the present disclosure relate to an electronic device such as a thermostat that may be disposed in a building (e.g., home or office). The electronic device may include a user interface configured to receive inputs, including inputs from a primary user (e.g., a resident of the home) and inputs from guests (e.g., visitors that are not residents of the home). The electronic device may, in some embodiments, determine whether a received input is indicative of a guest, and may provide the guest with controlled access to various systems within the home. By way of example, the electronic device may determine an identity of the guest, or may use identifying information relating to the guest, to determine whether the guest has predefined access to adjust settings to various systems within a home (e.g., HVAC settings). The guest's predefined access may be related to settings previously defined by the primary user, such as settings previously defined specifically for a particular guest, or settings previously defined for the type of guest (e.g., if the guest is a relative or friend). The primary user may also configure the guest's access on the fly, such as by using a mobile application on a personal electronic device (e.g., a smartphone).

The guest's access to the electronic device may be controlled in a number of ways. For example, if the electronic device is a thermostat that controls an HVAC system of the primary user's home, the guest's access may be limited to making temperature adjustments within a limited temperature range, within a limited timeframe, within a limited area of the home, or any combination thereof. The guest's access may, in some embodiments, include the ability to generate schedules within a predetermined timeframe, such as during a period of the guest's stay at the home.

Furthermore, while the guest is present and making adjustments to the thermostat, the thermostat may prevent the guest's adjustments from affecting the long-term operation of the HVAC system according to the primary user's schedule and settings. For example, the thermostat may either halt or terminate a learning mode associated with the primary user once the guest is detected/provided with guest access. Instead, any learning done by the thermostat may be tied specifically to the identity of the guest for future use (e.g., to auto-schedule settings adjustments).

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a block diagram of an electronic device that may be configured to operate in a guest mode to generate a safe sandbox for a primary user, in accordance with an embodiment;

FIG. 2 illustrates a block diagram of a home environment in which the general device of FIG. 1 may affect the operation of other devices in accordance with the guest mode, in accordance with an embodiment;

FIG. 3 illustrates an example method of operation for a safe sandbox device, in accordance with an embodiment;

FIG. 4 illustrates a schematic diagram of setting an electronic device into a guest mode, in accordance with an embodiment;

FIG. 5 illustrates a flow diagram of a method for identifying a guest and providing the identified guest with predetermined access, in accordance with an embodiment;

FIG. 6 illustrates a flow diagram of a method for identifying a guest and providing the identified guest with predetermined access after a confirmation by the primary user, in accordance with an embodiment;

FIG. 7 illustrates an example interface that a primary user may use to configure guest access, in accordance with an embodiment;

FIG. 8 illustrates an example interface that a primary user may use to configure guest access to various electronic devices, in accordance with an embodiment;

FIG. 9 illustrates an example interface that a primary user may use to configure guest access to an electronic device, in accordance with an embodiment;

FIG. 10 illustrates an example interface that a primary user may use to generate guest access to an electronic device, in accordance with an embodiment;

FIG. 11 illustrates an example interface that a primary user may use to enter guest-specific information relating to the guest's access, in accordance with an embodiment;

FIG. 12 illustrates an example interface that a primary user may use to limit a guest's access to an electronic device, in accordance with an embodiment;

FIG. 13 illustrates an example interface that a primary user may use to configure guest access to an additional electronic device, in accordance with an embodiment;

FIG. 14 illustrates an example interface that a primary user may use to configure guest access to a whole home environment, in accordance with an embodiment;

FIG. 15 illustrates an example mobile interface that a primary user may use to configure guest access on the fly, in accordance with an embodiment;

FIG. 16 illustrates an example mobile interface that a primary user may use to configure guest access for multiple guests, in accordance with an embodiment;

FIG. 17 illustrates an example mobile interface that a primary user may use to configure guest access, in accordance with an embodiment;

FIG. 18 illustrates an example mobile interface that a primary user may use to configure guest access, in accordance with an embodiment;

FIG. 19 illustrates a schematic diagram of an identified guest setting a schedule on a safe sandbox electronic device, in accordance with an embodiment;

FIG. 20 illustrates a method for recognizing the presence of a guest and auto-initiating a guest mode based on a comparison of the use of an electronic device to historical use trends, in accordance with an embodiment;

FIG. 21 illustrates a method for controlling guest access to an electronic home using guest-specific access codes, in accordance with an embodiment;

FIG. 22 illustrates a method of controlling guest access to an electronic device in real-time by providing prompts to a primary user, in accordance with an embodiment; and

FIG. 23 illustrates a method of controlling guest access to an electronic device when the electronic device is used in a vacation setting, in accordance with an embodiment.

### DETAILED DESCRIPTION

One or more specific embodiments of the present disclosure will be described below. These described embodiments are only examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but may nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

As noted in the summary above, embodiments of the present disclosure relate generally to electronic devices, such as thermostats, that enable guests to make settings adjustments to various energy-consuming systems, such as heating, ventilation, and air conditioning (HVAC) systems, while minimizing any deleterious effects of these settings adjustments on energy efficiency. Generally, a primary user of such devices in a home, such as a resident of the home, may desire to provide guest users, such as a guest temporarily visiting the home (e.g., not a resident of the home), with the freedom to adjust settings associated with various devices in order for the guest to feel comfortable while visiting. However, the primary user may also desire to maintain the energy efficient operation of the HVAC system established by a settings adjustment schedule previously created by the primary user. Indeed, manual adjustments by the guest user may not conform to the energy efficient settings previously established by the primary user.

In accordance with embodiments of the present disclosure, one or more thermostats may be placed into a guest mode of operation where the guest is able to adjust the temperature of the home or certain parts of the home (e.g., a guest bedroom) to the guest's desired temperature, without affecting the primary user's normal mode of operation when the guest is not present. In this example, the one or more thermostats, when placed into the guest mode of operation, may only have a limited functionality available to the guest. The functionality available to the guest may be limited to making temperature adjustments to only certain parts of the home, to making temperature adjustments only within a limited temperature range, to making temperature adjustments only within a limited time frame, or a combination thereof. Additionally or alternatively, the one or more thermostats, while in the guest mode, may learn from the guest's preferences and settings adjustments to generate a profile for the guest that enables energy efficiency similar to that established for the primary user's profile. In this way, the one or more thermostats can be placed into the guest mode of operation during future visits, and the guest will not have to make these settings adjustments again (or not have to make as many adjustments. That is, once the thermostat has learned a particular guest's preferred settings, the thermostat may be placed into a guest mode of operation specific to the guest so that the guest does not have to make as many adjustments to the thermostat.

Furthermore, the one or more thermostats may use a thermal profile of the home, generated by the primary user's previous settings adjustments, to implement the guest's desired settings. In other words, the one or more thermostats may determine the most efficient way to implement the guest's settings.

As another example, which can be additionally or alternatively implemented with respect to the example above, a primary user may provide a guest user with the ability to automatically enter the primary user's home, such as while the primary user is away, or in emergency situations. The primary user may also enable the guest user to receive messages (e.g., notifications on a smartphone) when an alarm of the primary user's home, such as a fire alarm, is activated. In this example, a thermostat system of the primary user's home, such as a networked thermostat system having one or more thermostats capable of wireless communication, may communicate with various other devices in the primary user's home, such as electronic locks, fire and smoke alarms, burglar alarms, lights, computers, and so forth, to enable the guest to access the home and/or receive such notifications. When the guest is granted access to the home, the thermostat system may also initiate the guest mode discussed above.

In addition to operating their devices efficiently and having increased control over these devices, consumers generally prefer to use user-friendly devices that involve a minimum amount of set up or initialization. That is, consumers would generally prefer to purchase devices that are fully operational after performing a few initialization steps that may be performed by almost any individual regardless of age or technical expertise.

Keeping this in mind, to enable devices to effectively implement various modes of operation, such as a guest mode, a thermostat system having one or more networked thermostats may enable a primary user to determine the level of control over the access that guests have in the home. For example, a primary user may, using any number of interfaces (e.g., a computer, a thermostat, a personal electronic device), enable a guest's desired settings to be imported from an online profile and implemented, enable a guest to make limited adjustments at various thermostats based on a generic guest mode, or enable a particular set of adjustments for particular guests.

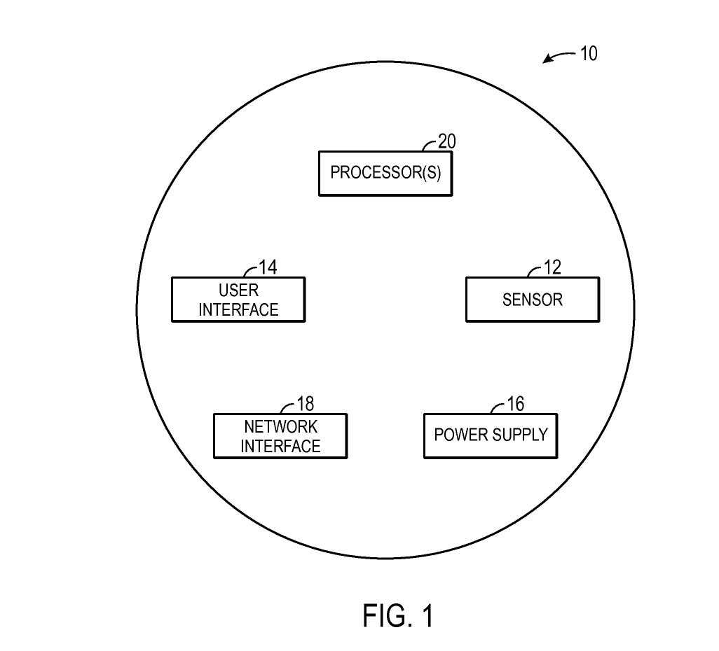

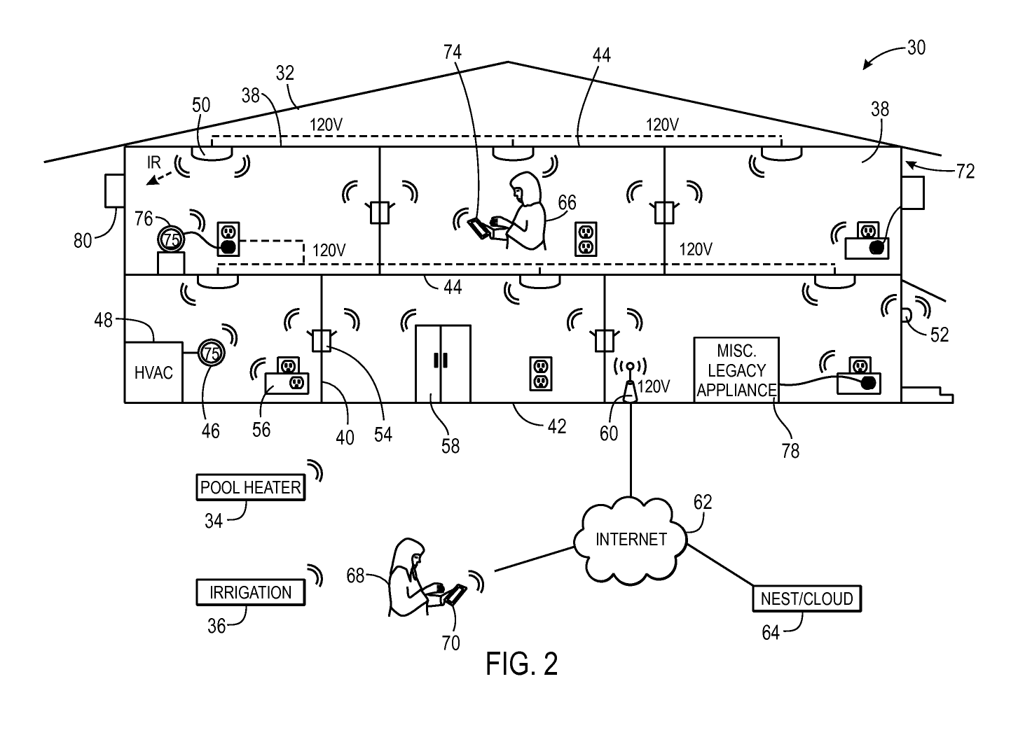

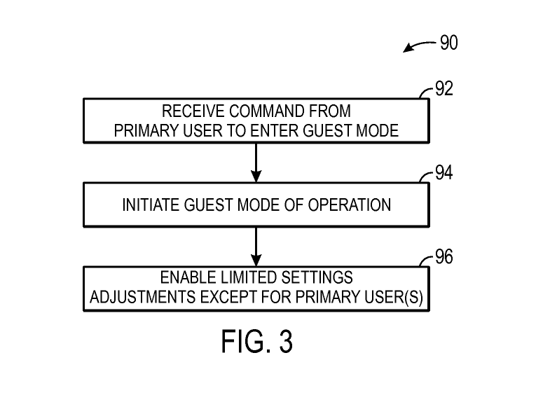

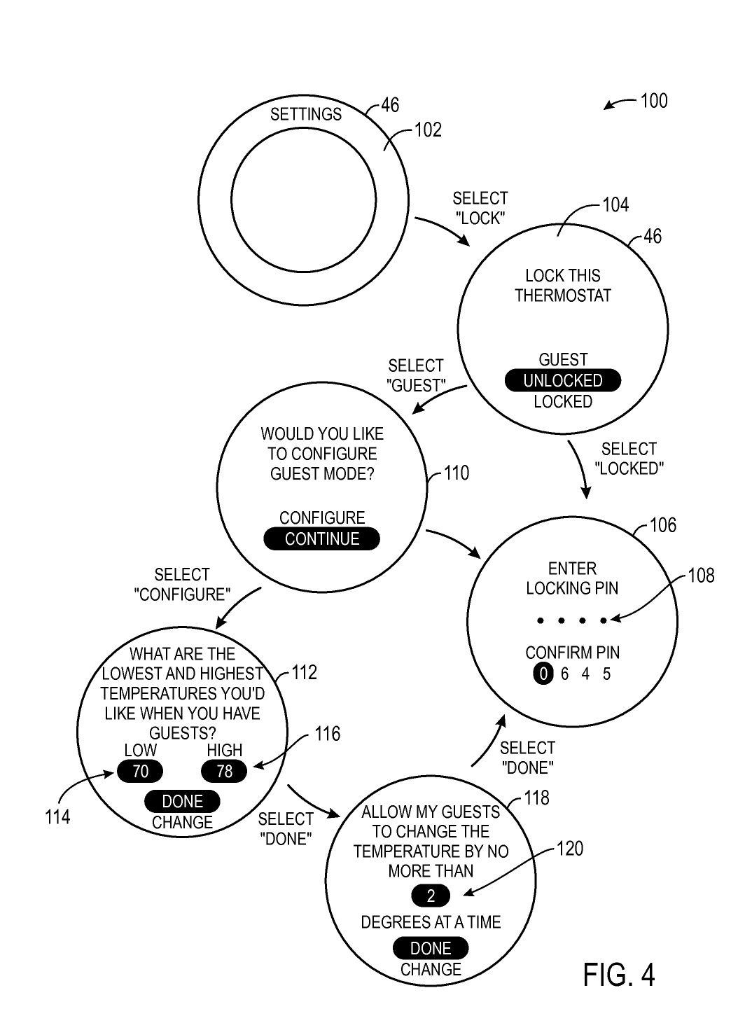

Presented hereinbelow are a number of sections intended to discuss various aspects of the present approaches. Specifically, Section I provides a discussion relating to the electronic devices and home environment systems that are capable of performing the acts described herein to enable guest modes of operation. Example embodiments of these systems are discussed below with respect to FIGS. 1 and 2. Section I also includes an introduction to the approaches toward creating a “safe sandbox” for the primary user, i.e., a home environment in which guests can interact with the environment without deleteriously affecting the operation of the primary user's home. Example embodiments of such approaches are discussed with respect to FIGS. 3 and 4.

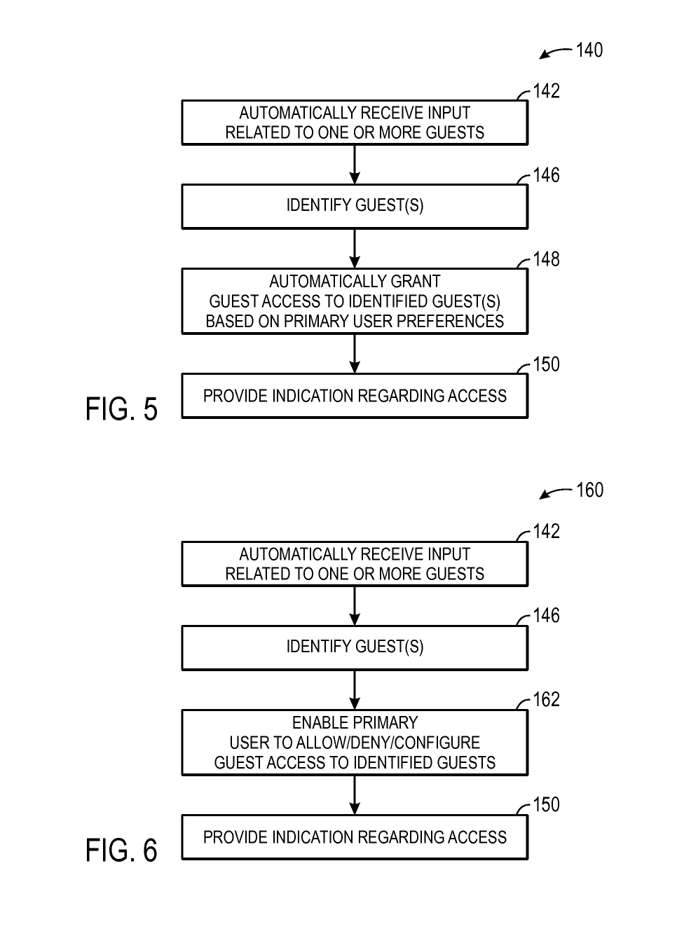

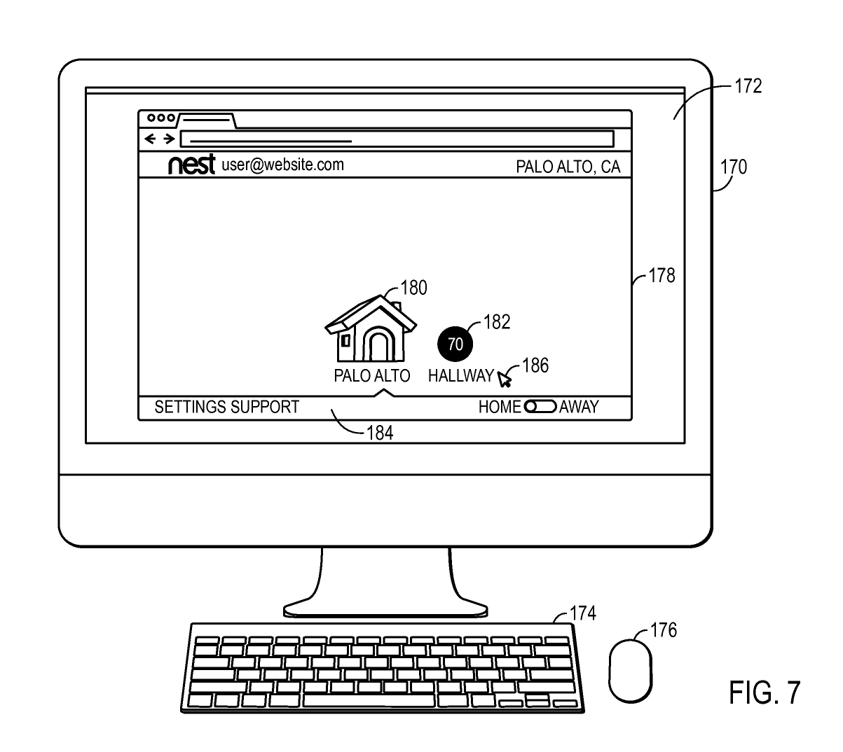

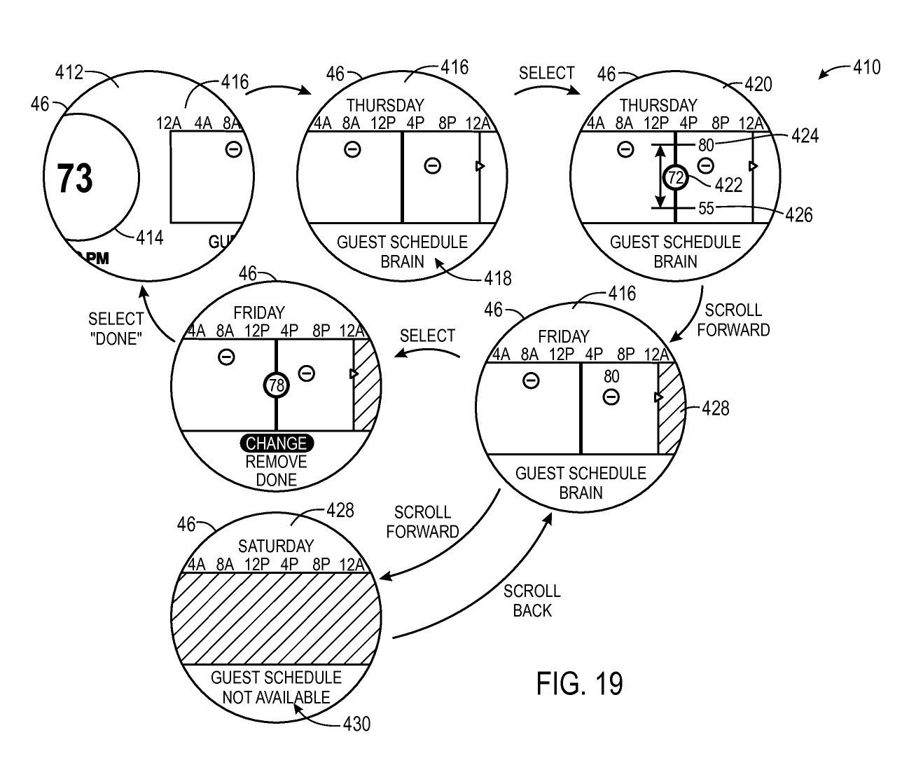

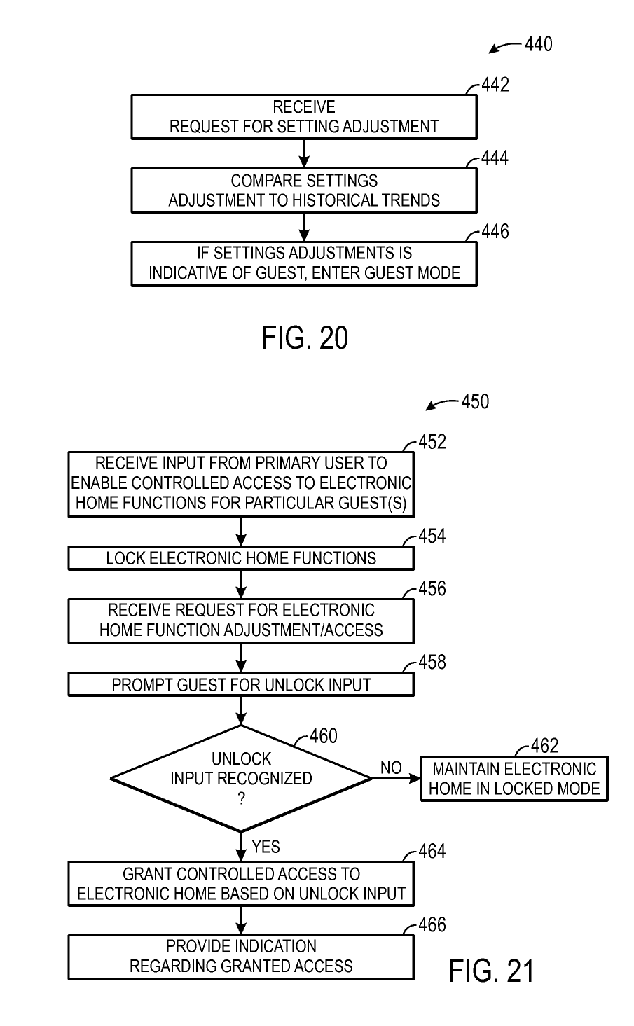

Section II includes a number of sub-sections that present various aspects and refinements of the safe sandbox approach for identified guests. In particular, Section II.A provides a general discussion relating to the auto-detection and identification of guests, and providing the identified guests with specific levels of access to the home's electronic devices. Example embodiments of these approaches are discussed with respect to FIGS. 5 and 6. Section II.B provides a discussion relating to the manner in which the primary user is able to create the safe sandbox based on configuring specific settings for identified guests. The manner in which the thermostats and the home environment operate based on these settings is also discussed with respect to these settings. Examples of settings adjustments that may be made in order to create the safe sandbox are discussed with respect to FIGS. 7-18, which depict example interfaces presented to a user in creating a guest profile or in configuring guest settings. An example embodiment of the manner in which an identified guest might interact with a safe sandbox thermostat (e.g., a thermostat in guest mode) is also discussed with respect to FIG. 19. Section II.C provides a discussion relating to the initiation of a guest mode of operation (thereby generating the safe sandbox) based on monitored use of electronic devices. An example embodiment of such an operation is discussed with respect to FIG. 20. Section II.D provides a discussion relating to controlling guest access to home electronic devices based on the use of guest-specific codes. An example embodiment of this approach is discussed with respect to FIG. 21.

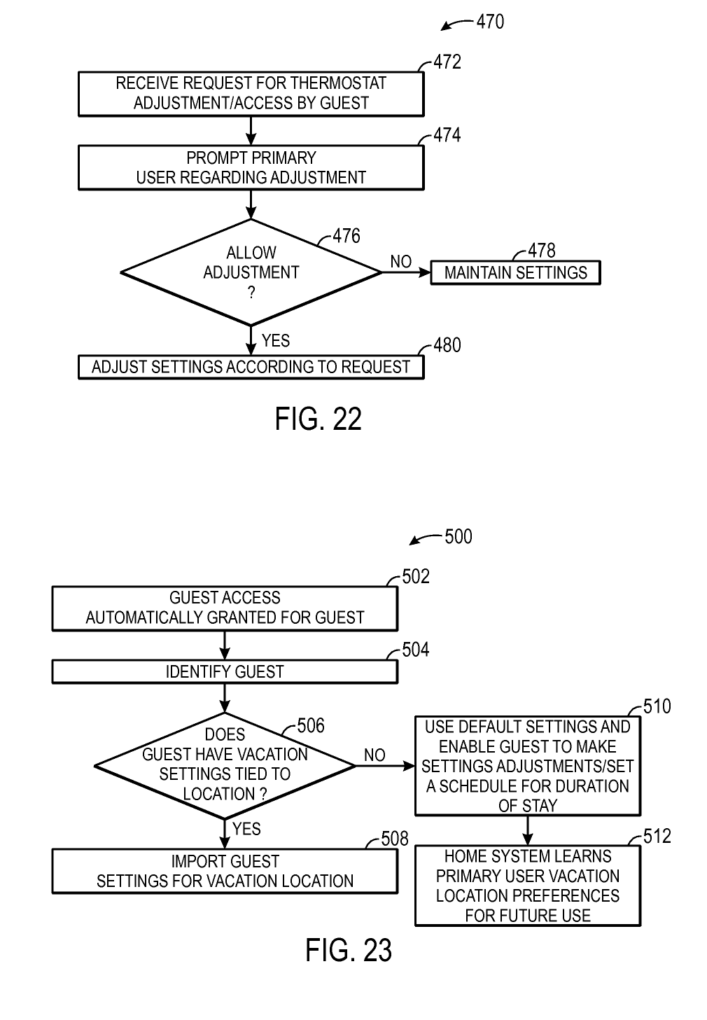

Section III provides a discussion relating to the control of guest access by the primary user in real-time, for example by allowing or denying requests using a mobile application. In this approach, a guest may not necessarily need to be identified in order for the primary user to control the guest's access. An example embodiment of this approach is discussed with respect to FIG. 22.

Section IV provides a discussion relating to the operation of a safe sandbox thermostat in a vacation-based context. An example embodiment of this approach is discussed with respect to FIG. 23.

I. System and Guest Mode Introduction

By way of introduction, FIG. 1 illustrates an example of a general device 10 that may communicate with other like devices within a home environment before and during implementation of a guest mode, for instance to generate a safe sandbox device. In one embodiment, the device 10 may include one or more sensors 12, a user-interface component 14, a power supply 16 (e.g., including a power connection and/or battery), a network interface 18, a processor 20, and the like. Particular sensors 12, user-interface components 14, and power-supply configurations may be the same or similar with each instantiation of the device 10 (e.g., for multiple such devices within a home). However, it should be noted that in some embodiments, each device 10 may include particular sensors 12, user-interface components 14, power-supply configurations, and the like based on a device type or model.

The sensors 12, in certain embodiments, may detect various properties such as acceleration, temperature, humidity, water, supplied power, proximity, external motion, device motion, sound signals, ultrasound signals, light signals, fire, smoke, carbon monoxide, global-positioning-satellite (GPS) signals, radio-frequency (RF), other electromagnetic signals or fields, and so forth. As such, the sensors 12 may include temperature sensor(s), humidity sensor(s), hazard-related sensor(s) or other environmental sensor(s), accelerometer(s), microphone(s), optical sensors up to and including camera(s) (e.g., charged coupled-device or video cameras), active or passive radiation sensors, GPS receiver(s) or radiofrequency identification detector(s). While FIG. 1 illustrates an embodiment with a single sensor, many embodiments may include multiple sensors. In some instances, the device 10 may include one or more primary sensors and one or more secondary sensors. Here, the primary sensor(s) may sense data central to the core operation of the device (e.g., sensing a temperature in a thermostat or sensing smoke in a smoke detector), while the secondary sensor(s) may sense other types of data (e.g., motion, light, or sound), which can be used for energy-efficiency objectives or smart-operation objectives.

One or more user-interface components 14 in the device 10 may receive input from the user and/or present information to the user. The received input may be used to determine a setting, an identity of the user, or other such information. In certain embodiments, the user-interface components 14 may include a mechanical or virtual component that responds to the user's motion. For example, the user can mechanically move a sliding component (e.g., along a vertical or horizontal track) or rotate a rotatable ring (e.g., along a circular track), or the user's motion along a touchpad may be detected. Such motions may correspond to a setting adjustment, which can be determined based on an absolute position of a user-interface component 14 or based on a displacement of a user-interface components 14 (e.g., adjusting a set point temperature by 1 degree F. for every 10° rotation of a rotatable-ring component). Physically and virtually movable user-interface components can allow a user to set a setting along a portion of an apparent continuum. Thus, the user may not be confined to choose between two discrete options (e.g., as would be the case if up and down buttons were used) but can quickly and intuitively define a setting along a range of possible setting values. For example, a magnitude of a movement of a user-interface component may be associated with a magnitude of a setting adjustment, such that a user may dramatically alter a setting with a large movement or finely tune a setting with a small movement.

The user-interface components 14 may also include one or more buttons (e.g., up and down buttons), a keypad, a number pad, a switch, a microphone, and/or a camera (e.g., to detect gestures). In one embodiment, the user-interface component 14 may include a click-and-rotate annular ring component that may enable the user to interact with the component by rotating the ring (e.g., to adjust a setting) and/or by clicking the ring inwards (e.g., to select an adjusted setting or to select an option). In another embodiment, the user-interface component 14 may include a camera that may detect gestures (e.g., to indicate that a power or alarm state of a device is to be changed). In some instances, the device 10 may have one primary input component, which may be used to set a plurality of types of settings. The user-interface components 14 may also be configured to present information to a user via, e.g., a visual display (e.g., a thin-film-transistor display or organic light-emitting-diode display) and/or an audio speaker.

The power-supply component 16 may include a power connection and/or a local battery. For example, the power connection may connect the device 10 to a power source such as a line voltage source. In some instances, an AC power source can be used to repeatedly charge a (e.g., rechargeable) local battery, such that the battery may be used later to supply power to the device 10 when the AC power source is not available.

The network interface 18 may include a component that enables the device 10 to communicate between devices. In one embodiment, the network interface 18 may communicate with other devices, such as handheld electronic devices, to receive settings adjustments and other commands and inputs, and to provide feedback as appropriate. The network interface 18 may communicate with such devices directly using any appropriate standard, or indirectly over a wireless network of a home. As such, the network interface 18 may include a wireless card or some other transceiver connection.

The processor 20 may support one or more of a variety of different device functionalities. As such, the processor 20 may include one or more processors configured and programmed to carry out and/or cause to be carried out one or more of the functionalities described herein. In one embodiment, the processor 20 may include general-purpose processors carrying out computer code stored in local memory (e.g., flash memory, hard drive, random access memory), special-purpose processors or application-specific integrated circuits, combinations thereof, and/or using other types of hardware/firmware/software processing platforms. In accordance with present embodiments, the processor 20 is specifically configured to be placed into a guest mode to control guest access to the device 10 (i.e., to generate a safe sandbox device).

The processor 20 may be implemented as localized versions or counterparts of algorithms carried out or governed remotely by central servers or cloud-based systems, such as by virtue of running a Java virtual machine (JVM) that executes instructions provided from a cloud server using Asynchronous JavaScript and XML (AJAX) or similar protocols. By way of example, the processor 20 may detect when a location (e.g., a house or room) is occupied, up to and including whether it is occupied by a specific person or is occupied by a specific number of people (e.g., relative to one or more thresholds). In one embodiment, this detection can occur, e.g., by analyzing microphone signals, detecting user movements (e.g., in front of a device), detecting openings and closings of doors or garage doors, detecting wireless signals, detecting an IP address of a received signal, detecting operation of one or more devices within a time window, or the like. Moreover, the processor 20 may include image recognition technology to identify particular occupants or objects.

In certain embodiments, the processor 20 may also include a high-power processor and a low-power processor. The high-power processor may execute computationally intensive operations such as operating the user-interface component 14 and the like. The low-power processor, on the other hand, may manage less complex processes such as detecting a hazard or temperature from the sensor 12. In one embodiment, the low-power processor may wake or initialize the high-power processor for computationally intensive processes.

In some instances, the processor 20 may predict desirable settings and/or implement those settings. For example, based on the presence detection, the processor 20 may adjust device settings to, e.g., conserve power when nobody is home or in a particular room or to accord with user preferences (e.g., general at-home preferences or user-specific preferences). As another example, based on the detection of a particular person, animal or object (e.g., a child, pet, or lost object), the processor 20 may initiate an audio or visual indicator of where the person, animal, or object is or may initiate an alarm or security feature if an unrecognized person is detected under certain conditions (e.g., at night or when lights are off). Similar indications may also be provided when a guest is arriving at the home.

In some instances, devices may interact with each other such that events detected by a first device influences actions of a second device, such as to notify or prompt a primary user for an input. For example, a first device can detect that a user has pulled into a garage (e.g., by detecting motion in the garage, detecting a change in light in the garage or detecting opening of the garage door), or that a guest user has arrived (e.g., by detecting motion at the front door, by receiving a signal from a smartphone or smart vehicle of the guest). The first device can transmit this information to a second device to adjust a home temperature setting, a light setting, a music setting, and/or a security-alarm setting. As another example, a first device can detect a guest user approaching a front door (e.g., by detecting motion or sudden light pattern changes and/or wireless signals specific to the guest). The first device may, e.g., cause a general audio or visual signal to be presented (e.g., such as sounding of a doorbell), may cause a second device of the primary user (e.g., a smartphone, television, or computer) to notify the primary user of the guest's presence and/or to prompt the primary user to allow the guest to enter the home, adjust settings to thermostats and other energy-consuming devices, and the like.

By way of example, the device 10 may include a thermostat such as a Nest® Learning Thermostat. Here, the thermostat may include sensors 12 such as temperature sensors, humidity sensors, and the like such that the thermostat may determine present climate conditions within a building where the thermostat is disposed. The power-supply component 16 for the thermostat may be a local battery such that the thermostat may be placed anywhere in the building without regard to being placed in close proximity to a continuous power source. Since the thermostat may be powered using a local battery, the thermostat may minimize its energy use such that the battery is rarely replaced.

In one embodiment, the thermostat may include a circular track that may have a rotatable ring disposed thereon as the user-interface component 14. As such, a user may interact with or program the thermostat using the rotatable ring such that the thermostat controls the temperature of the building by controlling a heating, ventilation, and air-conditioning (HVAC) unit or the like. The thermostat may be placed into a guest mode of operation where control of the HVAC unit by the guest may be limited based on the preferences of the primary user (e.g., based on instructions or constraints preconfigured by the primary user). The thermostat may determine that the user is a guest, and enable controlled access to the guest by a number of methods such that the primary user has created a safe sandbox home environment. Such methods are discussed in detail below.

In some instances, the thermostat may determine that the guest is present, and may adjust its operation accordingly. For instance, if, when not in guest mode, the thermostat is programmed to keep the HVAC unit powered off for an extended period of time according to a schedule established by the primary user, the thermostat may determine that the building will be vacant during this period of time. The thermostat may be programmed to control other devices, such as lights, during this time, and may turn off light switches or other electronic devices when it determines that the building is vacant. However, when the thermostat is in the guest mode, such as based upon the recognition of a guest occupancy, or based upon an input from a primary user, the thermostat may initiate a guest mode of operation where the primary user's settings may be superseded by the guest's adjustments, to an extent that is ultimately controlled and defined by the primary user. For example, when the thermostat detects that a guest such as a relative is present, the thermostat may cause a guest room (which would otherwise be vacant) to be cooled/heated to a temperature that is comfortable for the guest (e.g., based on a primary user input and/or based on the guest's input). The thermostat may also detect that the guest is approaching the guest room, and may turn on a light in the guest room, a fan in the guest room, a television in the guest room, or any number of other devices. Likewise, if the thermostat determines that the guest is likely asleep (e.g., by a lack of motion), the thermostat may cause any one or a combination of these devices to turn off. For example, the thermostat may detect that the guest is asleep, and may turn the television in the guest room off.

Keeping the foregoing in mind, FIG. 2 illustrates a schematic diagram of a home environment 30 in which the device 10 of FIG. 1 may be placed in to a guest mode of operation. The depicted home environment 30 may include a structure 32 such as a house, office building, garage, or mobile home. It will be appreciated that devices can also be integrated into a home environment that does not include an entire structure 32, such as an apartment, condominium, office space, or the like. Further, the home environment 30 may control and/or be coupled to devices outside of the actual structure 32. Indeed, several devices in the home environment 30 need not physically be within the structure 32 at all. For example, a device controlling a pool heater 34 or irrigation system 36 may be located outside of the structure 32.

The depicted structure 32 includes a number of rooms 38, separated at least partly from each other via walls 40. The walls 40 can include interior walls or exterior walls. Each room 38 can further include a floor 42 and a ceiling 44. Devices can be mounted on, integrated with and/or supported by the wall 40, the floor 42, or the ceiling 44.

The home environment 30 may include a plurality of devices, including intelligent, multi-sensing, network-connected devices that may integrate seamlessly with each other and/or with cloud-based server systems to provide any of a variety of useful home objectives. One, more than one, or each of the devices illustrated in the home environment 30 may include one or more sensors 12, an embodiment of the user interface 14, an embodiment of the power supply 16, an embodiment of the network interface 18, an embodiment of the processor 20, and the like.

Example devices 10 may include a network-connected thermostat 46 such as Nest® Learning Thermostat—1st Generation T100577 or Nest® Learning Thermostat—2nd Generation T200577. The thermostat 46 may detect ambient climate characteristics (e.g., temperature and/or humidity) and control a heating, ventilation and air-conditioning (HVAC) system 48. Another example device 10 may include a hazard detection unit 50 such as a Nest® Protect smoke and carbon monoxide (CO) alarm. The hazard detection unit 50 may detect the presence of a hazardous substance and/or a hazardous condition in the home environment 30 (e.g., smoke, fire, or carbon monoxide).

Another example of one of the devices 10 is an entryway interface device 52, such as a “smart doorbell.” The entryway interface device 52 may detect a person's approach to or departure from a location, control audible functionality, announce a person's approach or departure via audio or visual means, or control settings on a security system (e.g., to activate or deactivate the security system).

In certain embodiments, the devices 10 may include a light switch 54 that may detect ambient lighting conditions, detect room-occupancy states, and control a power and/or dim state of one or more lights. In some instances, the light switches 54 may control a power state or speed of a fan, such as a ceiling fan. In this regard, the light switches 54 (or other similar devices) may be adjusted automatically through a continuous range of operation, resulting in dimmed lights, slowed fan speeds, and so forth.

Additionally, wall plug interfaces 56 may detect occupancy of a room or enclosure and control supply of power to one or more wall plugs (e.g., such that power is not supplied to the plug if nobody is at home). The device 10 within the home environment 30 may further include an appliance 58, such as refrigerators, stoves and/or ovens, televisions, washers, dryers, lights (inside and/or outside the structure 32), stereos, intercom systems, garage-door openers, floor fans, ceiling fans, whole-house fans, wall air conditioners, pool heaters 34, irrigation systems 36, security systems, electronic door locks, and so forth. While descriptions of FIG. 2 may identify specific sensors and functionalities associated with specific devices, it will be appreciated that any of a variety of sensors and functionalities (such as those described throughout the specification) may be integrated into the device 10.

In addition to containing processing and sensing capabilities, each of the example devices described above may be capable of data communications and information sharing with any other device, as well as to any cloud server or any other device that is network-connected anywhere in the world. In one embodiment, any one or a combination of the devices 10 may send and receive communications via a network to implement settings associated with a guest and/or the primary user in any appropriate combination.

In one embodiment, a wireless router 60 may further communicate with the devices 10 in the home environment 30 via the home's network. The wireless router 60 may then communicate with the Internet 62 such that each device 10 may communicate with a central server or a cloud-computing system 64 through the Internet 62. The central server or cloud-computing system 64 may be associated with a manufacturer, support entity or service provider associated with a particular embodiment of the device 10. As such, in one embodiment, a user may contact customer support using a device itself rather than using some other communication means such as a telephone or Internet-connected computer. Software updates can be automatically sent from the central server or cloud-computing system 64 to the devices (e.g., when available, when purchased, or at routine intervals). Further, the central server or cloud-computing system 64 may also store and send user preferences to one or more of the devices 10 to implement settings associated with the guest. In this way, a guest 66 does not have to input every setting for every device. Rather, settings, such as the guest's home settings or visitation settings, may be imported into one or more of the devices 10, and may be implemented using data learned from the primary user's past use of the devices 10. In this way, settings/profiles associated with any number of guests can be imported and implemented.

By virtue of network connectivity, one or more of the devices 10 may further allow a user to interact with the device even if the user is not proximate to the device. For example, a primary user 68 may communicate with a device using a computer (e.g., a desktop computer, laptop computer, or tablet) or other portable electronic device (e.g., a smartphone) 70 to place the devices 10 into guest mode or to set profiles for one or more guests on the devices 10. Additionally or alternatively, the guest user 66 might request access or request a settings adjustment to one of the devices 10 to initiate guest user configuration processes available to the primary user 68. A webpage or application may receive communications from the primary user 68 and control the device 10 based on the received communications and, if the guest 66 is granted appropriate access, based at least partially on the guest's adjustments.

For example, the guest user 66 may be granted access to the device 10 in an upstairs location 72 of the home, and the guest user 66 may make adjustments to a temperature setting using a mobile application on the guest's portable electronic device 74. Meanwhile, the webpage or application may present information about the device's operation and settings to the primary user 68 via the primary user's portable electronic device 70. For example, the primary user 68 may receive a communication that the guest 66 has requested changes to temperature set points of an upstairs thermostat 76, and the webpage or application may enable the primary user 68 to allow the adjustments, or simply to notify the primary user 68 that the adjustment has been made. Such adjustments, notifications, access requests, and so forth, may be carried out using, for example, any combination of devices that may be connected to the Internet 62 and/or to a local network. In this example, the upstairs thermostat 76 may receive a current set point temperature view request via a wireless network, which may be presented to the primary user 68 and/or the guest user 66 over the wireless network on the portable electronic devices 70, 74, or another computing device (e.g., a computer).

In certain embodiments, the home environment 30 may also include a variety of non-communicating legacy appliances 78, such as conventional washer/dryers, refrigerators, and the like which can be controlled, albeit coarsely (ON/OFF), by virtue of the wall plug interfaces 56. The home environment 30 may further include a variety of partially communicating legacy appliances 80, such as infra-red (IR) controlled wall air conditioners or other IR-controlled devices, which can be controlled by IR signals provided by the hazard detection units 50 or the light switches 54.

Each of the example devices 10 described above may be operated in accordance with a guest mode, where control over the devices 10 is established for guests (e.g., the guest 66) via different levels of access to the devices 10 compared to the primary user 68 in the home environment 30. Indeed, the primary user 68 may define the level of access for one or more of the devices 10 for particular guests, for particular devices, and/or may simply enable a common guest mode of operation for a number of guests in the home environment 30. It should be appreciated that while the embodiments described in detail below are presented in the context of a thermostat system, the present disclosure is also intended to encompass other devices capable of performing the tasks described herein, including home alarm systems, hazard detection systems, or other home-integrated devices.

The guest mode of operation for a particular device 10 within the home environment 30, which may be initiated, for example, for a thermostat system including the thermostat devices described above with respect to FIG. 2, may generally operate according to whether or not the guest 66 is identified. However, it should be noted that the thermostat system may operate in a guest mode where both identified guests and unidentified guests are present, with the embodiments described below accordingly being performed in any suitable combination. In certain embodiments, it may be desirable to identify those guests who are present in the home environment 30, for example to enable learning from the guests' settings adjustments, to enable some guests to have greater control over the devices 10 than other guests, and so on. Such embodiments are described in further detail below.

Consider, for instance, a situation in which a primary user of the home environment 30 has many guests over, such as a party or other gathering. In order to avoid inefficient operation of the HVAC system due to several adjustments by the guests, the primary user may wish to limit the adjustments that may be made to the HVAC system via the thermostats 46. However, the primary user might also want to provide some level of control at the thermostats 46, albeit within certain defined bounds. One way the primary user may accomplish this is to manually set one or more of the thermostats 46 into guest mode in accordance with the method 90 depicted in FIG. 3.

As illustrated by the process flow diagram of FIG. 3, the thermostat system, for example one or more of the thermostats 46, may receive (block 92) a command from the primary user to enter a guest mode of operation. The primary user may enter this command via the thermostat's user interface 14 (e.g., physically at the thermostat), via the personal electronic device 70 (e.g., smartphone or tablet), at a computer, or any combination thereof. In its broadest sense, the guest mode of operation may or may not be tied to the identity of the guests visiting the home environment 30. In one embodiment, the guest mode of operation may be a single mode for all guests that may be pre-established by the manufacturer, and may be configurable by the primary user using any suitable interface (e.g., the personal electronic device 70).

Upon receipt of the command according to the acts represented by block 92, the thermostat 46 (or other device 10) may initiate (block 94) the guest mode of operation. Initiation of the guest mode may include any number of acts, including but not limited to suspending or terminating a learning mode associated with the primary user, continuing to learn but not making as aggressive changes to a primary user's settings, providing one or more user-perceivable indications (e.g., visual and/or audio) that the guest mode has started, adjusting settings (e.g., temperature settings) to those associated with the guest mode, adjusting a thermal profile of the home environment 30 to account for additional users, or any combination thereof.

Once the guest mode is initiated according to the acts represented by block 94, the settings adjustments available to users may be limited (block 96) unless the user is a primary user. For example, the available adjustments may be limited by the type of adjustment, including whether the adjustment is a heating or cooling adjustment, a schedule adjustment, an adjustment with settings associated with other devices (e.g., fans, light switches, appliances), or the like. The available adjustments may also be limited in magnitude, for instance such as limited to within a predetermined temperature range. For example, if the thermostat system determines that the HVAC system is efficient when operating within a certain temperature range, the settings adjustments may be limited to this range. Additionally or alternatively, the primary user may input the temperature range adjustments, for example such that the guests are only able to adjust the temperature setting of the thermostat 46 by no more than a certain temperature magnitude (e.g., 1 degree Fahrenheit, 5 degrees Fahrenheit). The temperature setting adjustment may be relative to a temperature setting of the thermostat 46 upon placement into the guest mode, or relative to the temperature setting of the thermostat 46 before adjustment.

The primary user may, at some point, desire to make changes to the thermostat 46 (or other device) outside of the predefined bounds set by the guest mode. Accordingly, in certain embodiments, the device 10 may automatically detect the primary user using any available technology, such as by receiving a wireless signal indicative of the primary user (e.g., a smartphone signature or a wireless signature from an application on the primary user's device 70, a wireless signature from a near-field communication device), by facial recognition, biometric recognition, gait analysis, audio recognition, or any other automatic recognition method. Upon recognizing the primary user, the device 10 may suspend or terminate the guest mode to enable the primary user to make any desired adjustments. When the primary user is done with any desired adjustments, the device 10 may return to the guest mode of operation as appropriate, unless the primary user has terminated the guest mode.

In other embodiments, the primary user may manually suspend or terminate the guest mode to make adjustments. For example, the primary user may input an unlock code associated with the primary user, where the code may be in the form of a personal identification number, a code that is scanned from a device (e.g., a barcode or a quick response (QR code)), or any other code. Additionally or alternatively, the primary user may suspend or terminate the guest mode using a command provided via the personal electronic device 70. An example sequence 100 of the manner in which a primary user may interface with the thermostat 46 (or other device 10 to set the thermostat 46 (or other device 10) into a general guest mode of operation is depicted in FIG. 4.

While the primary user may utilize any number of methods to interface with the thermostat 46, the sequence 100 of FIG. 4 depicts example screens that may be presented to the primary user as the thermostat 46 is navigated through a series of menus. A first screen 102, as depicted, may correspond to a lock settings screen with a menu associated with locking the thermostat 46. The first screen 102 may be presented to the primary user, for example, via navigation from a main screen of the thermostat 46 and to a settings menu of the thermostat 46. As depicted, the first screen 102 may present the primary user with a list of options, which may include an option to lock the thermostat 46 or to unlock the thermostat 46 as illustrated, or may include other options not illustrated, such as other options associated with locking the thermostat 46 including unlock codes, profiles, and so forth.

Upon selecting “LOCK,” for example by an inward click on the thermostat's face or a select button on the thermostat's keypad, the thermostat 46 may present a second screen 104. The second screen 104, as illustrated, may enable the primary user to select between various locking options, including locking the thermostat 46 in a “LOCKED” mode, unlocking the thermostat 46 into an “UNLOCKED” mode, or setting the thermostat 46 into a “GUEST” mode. Other types of modes that may be selected to control adjustments at the thermostat 46 are presently contemplated, including those configured to limit adjustments by particular types of users (e.g., a relative or a child).

When the primary user selects “LOCKED,” the thermostat 46 may then present a third screen 106, which may be a code input screen. As depicted, the third screen 106 may require the primary user to input a code 108, which is illustrated as a personal identification number (PIN), but may be selected from any other type of code, including bar codes, QR codes, and the like, or may be input via a scan of the primary user's eye, face, finger, hand, or other identifying characteristic. In other embodiments, other code input interfaces may be presented, such as a visualization of a combination lock that enables the primary user to input a particular combination of numbers in the same manner as done for a traditional rotary combination lock.

At the second screen 104, the primary user may navigate to a menu related to a guest mode. For example, the primary user may highlight and select the “GUEST” option on the second screen 104 to present a fourth screen 110. At the fourth screen 110, the thermostat 46 may present the primary user with a variety of options, such as the ability to “CONTINUE” to the third screen 106 to lock the thermostat 46 into guest mode if the primary user desires to use a previously-configured set of settings (e.g., manufacturer settings) for the guest mode. On the other hand, the primary user may select “CONFIGURE” to adjust settings associated with the guest mode.

The thermostat 46 may present a fifth screen 112 to present options associated with the thermostat's guest mode of operation. Among other potential settings adjustments, the thermostat 46 may enable the primary user to determine a low setpoint temperature 114 and a high setpoint temperature 116, which are used to define a temperature set point range in which guests are able to make adjustments. In this example, a guest would not be able to adjust a temperature set point at the thermostat lower than 70 degrees Fahrenheit or higher than 78 degrees Fahrenheit. However, the primary user may select “CHANGE” to adjust the upper and lower bounds, for example to increase or decrease the low setpoint temperature 114 and/or to increase or decrease the high setpoint temperature 116. In certain embodiments, the thermostat 46 may provide one or more user-perceivable indications, such as a green leaf on the display of the thermostat 46 and/or an audible tone indicating that the range selected by the primary user is considered to be an energy efficient temperature range.

Once the primary user is satisfied with the temperature range set forth on the fifth screen 112, the primary user may select “DONE,” and navigate to a sixth screen 118. The sixth screen 118 may present an adjustment magnitude entry 120 to select the magnitude by which the temperature setpoint may be changed by a guest user. In this example, the primary user is enabling guests to make adjustments in 2 degree Fahrenheit increments. In other words, guest users are able to adjust the temperature setpoint of the thermostat 46 within a range of 2 degrees Fahrenheit lower and 2 degrees Fahrenheit higher than the current temperature setpoint. If the guest users attempt to adjust the temperature setpoint outside of this range, the thermostat 46 may either not respond, may adjust the temperature setpoint by 2 degrees Fahrenheit in accordance with the desired setting, may provide an indication that the thermostat 46 is in guest mode, or may request an input code to unlock the thermostat 46 out of the guest mode, or any combination thereof.

Indeed, in addition to the temperature range selected by the primary user at the fifth screen 112, the magnitude by which the temperature set point of the thermostat 46 is changed may affect the overall efficiency of the HVAC system's operation. For example, in accordance with certain embodiments, 1 or 2-degree Fahrenheit differences may be achieved by adjusting the operation of fans, lights, and other similar devices in addition to or in lieu of the HVAC system. That is, lights may, in addition to consuming energy, generate certain amounts of heat, while fans, while energy consuming, may cool a room (or at least make the room be perceived as cooler by occupants). Thus, adjusting these or similar devices may cause smaller amounts of energy to be consumed by the HVAC system in order to achieve the small temperature difference request. Indeed, smaller temperature difference requests may, in a general sense, require less energy than larger temperature difference requests, even if the only system or device adjusted is the HVAC system.

However, if a 10-degree Fahrenheit difference is requested, large amounts of power may be required by the HVAC system (e.g., due to a longer time in operation and/or due to the use of additional heating or cooling stages) and, in turn, introduce inefficiency. Accordingly, the thermostat 46 enables control over the magnitude by which guests are able to adjust the temperature set point, in addition to or in lieu of enabling control over the temperature setpoint request by the guest. This control may serve to maintain the energy efficiency of the primary user's HVAC system.

The primary user may change the adjustment magnitude entry 120 on the sixth screen 118 by selecting “CHANGE” at the bottom of the thermostat 46, and selecting a desired magnitude entry. In certain embodiments, the thermostat 46 may provide positive feedback to the primary user, such as visual feedback (e.g., a green leaf), when the adjustment magnitude entry 120 is within a range that is considered to be energy efficient, such as 2 degrees Fahrenheit. On the other hand, the thermostat 46 may provide a less-positive feedback (e.g., a yellow leaf) or no feedback when the adjustment magnitude entry 120 is within a small range of the energy efficient setting, such as 5 degrees Fahrenheit, or a negative feedback (e.g., a red leaf) or no feedback when the adjustment magnitude entry 120 is too large, such as 10 degrees Fahrenheit.

Once the primary user is satisfied with the selected adjustment magnitude entry 120, the primary user may select “DONE,” and the thermostat 46 may navigate to the third screen 106 to enable the primary user to lock the thermostat 46 into the guest mode of operation by inputting the code 108. The code 108 used to lock the thermostat 46 into the guest mode of operation may be the same code or a different code used to lock the thermostat 46 into the locked mode where no adjustments can be made to the thermostat 46 without an unlock code (or where functionality is more limited compared to the guest mode).

It should be noted that the screens and options discussed above are examples only, and are not intended to limit the scope of the present disclosure. Indeed, any number of other options associated with the guest mode may be presented to the primary user during navigation through the thermostat's settings. For example, the thermostat 46 may enable the primary user to correlate certain guest mode settings to certain guests, which may be identified by the thermostat 46 or by another device 10 connected to the network of the home environment 30. Additionally or alternatively, the thermostat 46 may present the primary user with the option to set additional thermostats within the home environment 30 (e.g., the upstairs thermostat 76 of FIG. 2) into the guest mode of operation. In such embodiments, the primary user may use the same settings for the guest mode of operation for all of the thermostats 46, or may configure different thermostats 46 to have different settings while in the guest mode. For example, the upstairs thermostat 76, while in the guest mode, may enable the guest user to adjust the temperature setpoint to any desired value (e.g., a value outside of the range established for another thermostat 46), and at any magnitude of adjustment.

II. Primary User's Safe Sandbox for Identified Guests

Although a general guest mode may be desirable for situations where there are many guests visiting the home, correlating particular settings with particular guests may provide a number of advantages in terms of efficiency and guest comfort. For example, even though careful scheduling of the thermostat's settings can achieve desired levels of energy efficiency and provide the primary user with a great amount of control over the home environment 30, scheduling may not always be feasible. For instance, if the primary user is too busy to set a schedule for the duration of a guest's stay, or if the primary user is not able to anticipate the guest's arrival or desired settings, the primary user may eventually override the current settings of one or more of the thermostats 46 to enable the guest to make desired adjustments. Indeed, in order to enable the guest to subsequently control the thermostats 46, the primary user might even feel the need to provide the guest with the primary user's passcode to the thermostat 46, which can result in the guest user inadvertently affecting one or more of the primary user's preferred settings. It may therefore be desirable for the thermostats 46 to detect the guest, and, based on primary user input, grant or deny access to the guest to create a safe sandbox environment for the primary user. Thus, the thermostat 46 may create an environment where a guest can interact with the home devices, without affecting the primary user's preferences for those devices in the same way the primary user's interactions affect the preferences.

In order to enable enhanced functionalities for certain guests, such as enabling a learning mode tied to a particular guest and/or to enable different levels of access to be provided to certain guests, the thermostat 46 (e.g., any thermostat 46 within the home environment 30, or only a subset of thermostats 46 in the home environment) may identify guests. The identification may be automatic (e.g., based on one or more detection methods), or may be based on a manual input from the guest and/or the primary user, as discussed below. As an example, a learning mode tied to a particular guest may utilize a relatively aggressive auto-scheduling algorithm that uses between 2 and 4 temperature set point adjustments by the guest to auto-schedule temperature set points for a period of time (e.g., a week or other predetermined time period that is not permanent).

A. Auto-Detection of Guests

As noted above, in accordance with present embodiments, the primary user may configure access (e.g., create a specific profile) for a particular guest. However, in order for the thermostat 46 to provide the access to the guest, the guest may first be identified based on the receipt of data specific to the guest. By way of non-limiting example, the guest may be granted their specific access after the thermostat 46 (or another device 10) receives some identifying information for the guest. The identifying information may include manually-entered information such as a manually-entered code, a scanned personal code, and/or an input from a schedule generated by the primary user, or may include automatically-generated information, including biometric identification, gait analysis, personal electronic device data, or other such data. Embodiments in which the thermostat 46, or any other device communicatively coupled with the thermostat 46, automatically detects identifying information for a guest and uses this information to provide access to the guest are described in further detail below.

Further, while the manner in which the levels of access are correlated to the particular guests is not particularly limited, it will be appreciated that primary users may be more likely to configure access for particular guests if there is adequate time to do so, and/or if the interface is intuitive and user-friendly. For example, a primary user might pre-configure a guest mode for the thermostats 46 (or other such devices 10) before a particular guest arrives at the home (e.g., at a computer and/or at the thermostat 46). Such a situation may arise when the particular guest is going to be visiting the home for an extended period of time (e.g., longer than a day), or if the particular guest is a regular visitor (e.g., a friend, a member of a regularly-scheduled home service, a babysitter). In other situations, the primary user may configure a particular guest's access to the thermostats 46 (or other devices 10) on the fly, such as when one or more thermostats 46 identify that the guest has entered the home environment 30. For example, the primary user may configure access for the identified guest by allowing or denying certain functionalities for the guest, or may simply allow or deny all access for the identified guest. Embodiments of these two approaches are discussed below with respect to FIGS. 5 and 6.

In particular, FIG. 5 depicts an embodiment of a method 140 for automatically granting a predetermined level of access to a guest, such as when the guest enters the home environment 30. The method 140 may be performed by any combination of the devices 10 within the home environment 30 (e.g., one or more of the thermostats 46), either alone or in conjunction with other equipment (e.g., the cloud-based computer system 64). Indeed, the methods discussed herein may be performed by the thermostat 46 based on one or more sets of instructions stored on tangible, non-transitory, machine-readable media, as discussed above with respect to the processor 20. In certain embodiments, the thermostat 46 may access information that is stored on one or more of the computing devices of the cloud-based computer system 64, such as stored profiles for guests, identifying information for guests, etc. However, in other embodiments, the thermostat 46 may perform substantially all learning, profiling, storage of identifying information (e.g., a photograph, telephone number), and so forth, to implement the guest mode.

The method 140, as depicted, may include automatically receiving (block 142) one or more inputs relating to one or more guests. The one or more inputs that are automatically received may be representative of one or more identifying characteristics of the one or more guests. Generally, the input data may include identification data that is generated either by the thermostat 46 or by another device either in direct communication with the thermostat 46 or connected to the same wireless network as the thermostat 46. For example, the input data may be biometric identification data generated by the thermostat 46 or another device via the execution of facial recognition algorithms, voice recognition algorithms, or other algorithms that, when executed, generate biometric or similar data representative of a particular person (guest). In some embodiments, the thermostat 46 may utilize identifying information for the guest that is available to the primary user. The guest's identifying information may be, for example, obtained by the thermostat 46 via the primary user's photographs stored on their computer, personal electronic device, and so forth, or via associations on various Internet-based services such as social media networks, mail clients, video chat clients, and so forth. As an example, the thermostat 46 may compare a guest versus photographs associated with a list of the primary user's contacts in their phone.

As another example, the input data automatically received by the thermostat 46 may be wireless data generated by a device that is specifically tied to the guest. For example, the device may be a card, key, fob, or similar feature having a near-field communication device installed therein. In such instances, the near-field communication device may transmit data to the thermostat 46 (directly or indirectly through another device) that is indicative of the guest's identity. In still other embodiments, the device may be a smart device capable of transmitting and receiving data. The device may also include one or more processing components (e.g., processors, memory) specifically configured to process information, such as to generate guest-specific information, connect to the wireless network (e.g., via wireless router 60), respond to requests for information from the thermostat 46, another device 10 of the home environment 30 and/or the cloud-based computing system 64, control the thermostat 46 and/or other devices 10, or any combination thereof. By way of non-limiting example, such a smart device may include a smartphone, a tablet, a computer, a personal data assistant (PDA) device, a portable music player, a navigation device installed in a vehicle (e.g., a smart vehicle), or any other processor-based device having wireless communication capability.

Advantageously, in embodiments where the device of the guest is a portable electronic device (e.g., the portable electronic device 74 of FIG. 1), the guest may also have identifying information, settings information, and other such information, generated or otherwise associated with a mobile application that is configured to control the thermostat 46. For instance, in embodiments where the thermostat 46 is a Nest® Learning Thermostat—1st Generation T100577 or Nest® Learning Thermostat—2nd Generation T200577, the device may have the Nest® mobile application installed thereon, enabling the thermostat 46 to coordinate with the device and/or the cloud-based computing system 64 to determine the guest's identity based on data generated by (e.g., information stored on) the guest's device.

Once data representative of one or more guests (e.g., a guest input) is received, the thermostat 46 may identify the guests that are present within the home environment (block 144) based on the data. Based on the above discussion, it will be appreciated that the manner in which the guests are identified will depend, at least partially, on the type of data received and the manner in which the data is received. For example, if the input is data indicative of a guest's smartphone connected to the network of the home environment 30, the data may include information received from the smartphone (e.g., a MAC address, an e-mail address, account information, a phone number), or may be data generated in response to the smartphone's connection to the network, for instance where the cloud-based computing service 64 recognizes the smartphone data upon connection to the network and sends representative signals to the thermostat 46.

Once the guest is identified according to the acts represented by block 146, in the illustrated embodiment, the thermostat 46 may automatically grant access (block 148) to the identified guests for which the primary user has established a pre-configured access level. For example, the thermostat 46 may compare the guest's identity to the primary user's guest settings stored on a local computing device, and/or stored on the cloud-based computing service 30, and/or stored on the thermostat 46 (e.g., stored only on the thermostat 46). When the thermostat 46 determines that the primary user has established settings for the identified guest, the thermostat 46 may automatically grant the identified guest with access according to the primary user's settings that were previously established. Examples of the manner in which a primary user might configure guest settings for a particular guest are discussed below with respect to FIGS. 7-18 below.

Once the identified guest has been granted access according to the acts represented by block 148, in certain embodiments, the thermostat 46 may provide a user-perceivable indication (block 150) regarding this access. The indication may be audible, visual, tactile, or any combination thereof. For instance, once the identified guest is provided with access, the thermostat 46 may display text (or another visual indicator), may send a signal to the guest's portable electronic device to generate a message indicating the access, may sound an audible tone indicating that a person has been granted access, or any combination thereof.

The indication may, additionally or alternatively, be provided to the primary user. For instance, the primary user may receive an e-mail message, a text message, a phone alert, or a similar indication regarding the identified guest's access. In certain embodiments, the primary user may also be provided with the opportunity to re-configure the previously-established settings for the identified guest, or to subsequently revoke the identified guest's access.

In this regard, it may be desirable to enable the primary user to allow, deny, or re-configure access for one or more of the identified guests. FIG. 6 illustrates an embodiment of such a method 160 that enables the primary user to authorize guests when identified. Indeed, the method 160 may be performed in addition to, or in lieu of, the method 140 set forth in FIG. 5, depending, for instance, on the particular settings associated with certain guests. As such, the method 160 includes some of the same acts set forth above with respect to FIG. 5.

As depicted, the method 160 includes automatically receiving (block 142) an input related to one or more guests, and identifying (block 146) at least some of the guests in same manner set forth above with respect to FIG. 5. Once guests are identified according to these acts, the thermostat 46 (or another device 10 in communication with the thermostat 46) may enable the primary user to allow, deny, or configure/re-configure access for identified guests (block 162). Particular examples of the manner in which the acts represented by block 162 may be implemented are discussed in further detail below. However, in a general sense, the primary user may be presented with one or more selectable options correlated to particular guests.

The selectable options may enable the primary user to allow the guest to access the thermostat 46, to deny the guest access to the thermostat 46, and/or to enter into a menu-based system that enables the user to provide inputs to a variety of options to configure the guest's access. For example, during configuration, the primary user may limit the temperature adjustments that are available to the identified guest by limiting the selectable temperatures to a certain temperature range (e.g., a maximum and minimum temperature) and/or by limiting potential adjustments to a certain temperature adjustment magnitude (e.g., such that the identified guest is only able to adjust the temperature by a certain amount). The primary user may also limit the guest's ability to affect the learning of the thermostat 46, to create temperature schedules, to control the thermostat 46 remotely, and so on.

As discussed in further detail below, the configuration may be performed at any device that is capable of interacting with and controlling the thermostat 46, such as the thermostat 46 itself, a computing device, a smart device, or the like. For example, the acts according to block 162 may include providing the primary user with configuration options via the user interface 14 on the thermostat 46, on a mobile application running on the primary user's personal electronic device 70, or in any similar manner

Once the primary user has made selections for particular guests, the thermostat 46, or another device in communication with the thermostat 46, may provide indications to the identified guests, to the primary user, or a combination thereof, in accordance with block 150 discussed above with respect to FIG. 5. It should be noted that in situations where an identified guest is denied access, the thermostat 46 may not provide an indication to the guest, or may provide an indication that the thermostat 46 is locked.

B. Creating the Safe Sandbox

As discussed above with respect to FIGS. 5 and 6, the primary user may configure guest access in a number of ways and on a number of interfaces. Further, this configuration may occur before the guest arrives or after the guest arrives. Discussed hereinbelow with respect to FIGS. 7-18 are examples of interfaces that the primary user may use to configure guest settings. In situations where the primary user has the opportunity to configure access before the guest arrives, for instance, the primary user may use a computer 170, as depicted in FIG. 7. However, while the embodiments described below are presented in the context of using the computer 170, it should be appreciated that a number of interfaces may be used to perform these operations. For example, the example interfaces provided below (including the types of settings entries and other options) may be implemented on a tablet computer or on a smartphone or other personal electronic device (e.g., via the Internet and/or a mobile application), or may be implemented directly on the thermostat 46, for example where the thermostat 46 implements all or a part of the guest mode operations.

Furthermore, the various configuration options presented below are also intended to introduce various methods that may be performed by any one or a combination of the thermostats 46, either alone or in conjunction with other devices (e.g., sensors, computing devices, personal electronic devices, or the cloud-based computing system 64). Therefore, while certain embodiments presented below are discussed in the context of various configurable options available to the primary user, it should be noted that the presented embodiments are also intended to encompass embodiments of methods in which the thermostats 46, alone or in conjunction with the other appropriate devices, perform the appropriate steps to carry out these settings. Accordingly, it should be kept in mind that the options presented below may be implemented by any one or a combination of the devices 10 of the home environment 30 in combination with the thermostats 46 and/or the cloud-based computing system 64, or only by the thermostats 46, and so on.

In the illustrated embodiment, the computer 170 includes, in addition to processing equipment (e.g., one or more microprocessors, one or more storage mediums such as a storage drive), a user interface, such as a display 172. The display 172 may, in certain embodiments, simply display information to a user or, in other embodiments, may be a touchscreen interface. The computer 170 may also be connected to input devices, such as a keyboard 174 and a mouse 176, which enable the primary user to input information, make selections, and generally interact with the computer 170. While not specifically illustrated, the computer 170 may also include communication devices that enable the computer 170 to connect to the Internet (e.g., via the wireless router 60), the thermostats 46, personal electronic devices, and, in some embodiments, the cloud-based computer system 64.

As illustrated, the primary user has navigated to a webpage 178 of a home environment control service, such as a website hosted by the cloud-based computer system 64. In embodiments where the interface used is directly on the thermostat 46, however, the webpage 178 may instead be an interface displayed by the thermostat 46.

The primary user may be provided a home icon 180 of the home environment 30, a thermostat icon 182 corresponding to one or more of the thermostats 46, as well as a menu 184. When using the computer 170, the primary user may generally interact with each of the icons 180, 182 and the menu 184 by placing a cursor 186 over the particular icon 180, 182 or menu selection that the primary user wants to adjust. On the other hand, if using the thermostata 46, the primary user may generally interact with different options by scrolling, clicking, and so forth, using a user interface of the thermostat 46. For example, to adjust settings adjusted with the home environment 30, the primary user may select the home icon 180, and then select the “SETTINGS” option on the menu 184. The primary user may, for instance, create, adjust, or delete guest profiles under the settings menu (e.g., for the whole home environment 30 when the home icon 180 is selected). Similarly, the primary user would first select the thermostat icon 182 to adjust thermostat settings, for example to place one or more of the thermostats into a guest mode and/or to associate guests with particular thermostats 46 (e.g., a subset of the thermostats 46).

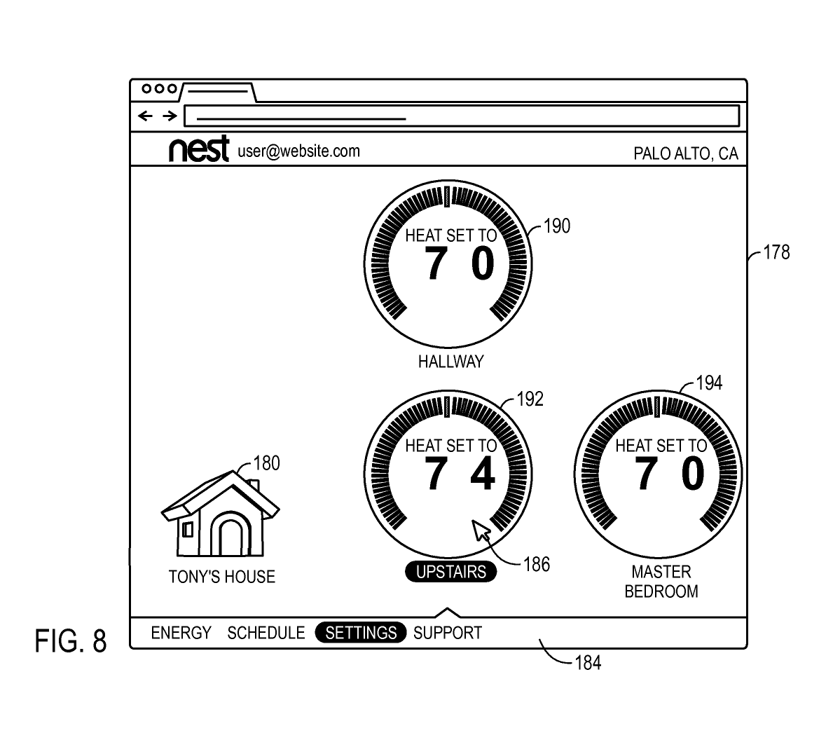

It will be appreciated that certain homes may have more than one thermostat 46 or other device 10 that may be placed into a guest mode of operation (e.g., separately or all at once). Accordingly, in certain embodiments, the webpage 178 (or other graphical interface, such as on the thermostat 46) may display multiple thermostat icons 182 corresponding to all of the thermostats 46 in the home environment 30. Such an embodiment is depicted in FIG. 8.

In the illustrated embodiment, the home icon 180 is personalized to reflect the primary user's name, and the thermostat icons 182 include a hallway thermostat icon 190 representing a thermostat positioned in a hallway, an upstairs thermostat icon 192 representing a thermostat positioned upstairs, and a master bedroom thermostat icon 194 representing a thermostat positioned in the master bedroom. The particular designations of each thermostat icon 182 are not limited, and are merely provided herein as examples. For instance, the thermostats 46 might include a living room thermostat or the like. Further, in other interfaces, the designations may be only textual, or may be presented in different screens.

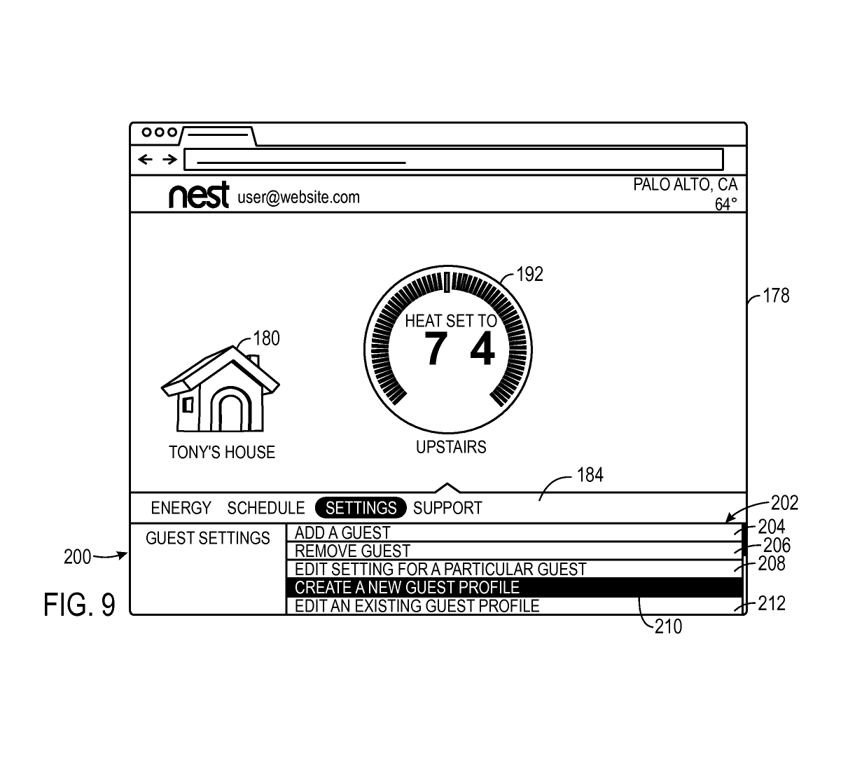

In accordance with present embodiments, the thermostats 46 and/or the service 64 may enable the primary user to configure each of the thermostats 46 to have its own guest settings by separately selecting a particular one of the thermostats (e.g., using icons 182), and adjusting the settings associated with the particular thermostat 46 (e.g., corresponding to that icon 182). Further, should the primary user desire to have the same settings for many of the thermostats 46, the primary user may select multiple thermostats 46 at once, or the primary user may copy the settings of one thermostat 46 to another, or a combination thereof. In the illustrated embodiment, the upstairs thermostat icon 192 is selected, indicating that the primary user will adjust settings associated with the upstairs thermostat (e.g., thermostat 76 of FIG. 2). As depicted in FIG. 9, the settings may include, among other things, guest mode settings associated with whichever thermostats 46 are selected (e.g., via their respective thermostat icons 182). In this way, the primary user may configure specific guest mode settings for each thermostat 46, which may result in the guest being provided with different levels of control (i.e., different levels of access) over the different thermostats 46 of the home environment 30.

Specifically, FIG. 9 depicts an embodiment where the webpage 178 (or other graphical user interface) includes a sub-menu 200 associated with guest settings for the upstairs thermostat. The guest settings sub-menu 200 may include a variety of configuration options 202 enabled by the service 64 and/or suitably configured thermostats 46 (e.g., in combination or only by the thermostats 46), including but not limited to a first option 204 to add a guest, a second option 206 to remove a guest, a third option 208 to edit settings associated with a guest, a fourth option 210 to create a new guest profile, and a fifth option 212 to edit an existing guest profile. While these options are presented in the context of the primary user's interactions, it should be noted that the interactions and the responses that result from the interactions are enabled via suitable configuration of the thermostats 46, either alone or in combination with the service 64.

The first option 204, as noted above, enables the primary user to add a guest. For example, the primary user may select the first option 204 in order to create a profile for a particular guest. In creating the profile, the primary user may enter information relating to the guest's access, such as adjustments available to the guest, identifying information for the guest (e.g., phone number, e-mail address, a picture), and enabling home alerts for the guest. These settings may be stored, for example, on a local memory of the thermostat 46 and/or by the service 64. Further, in certain embodiments, the primary user may also associate the guest's access with a particular timeframe. For example, the primary user may configure a profile for a particular guest that will be visiting for a certain amount of time. The primary user may adjust the profile such that the settings adjustments that are available to the guest are only available for the duration of the guest's stay, rather than providing the availability for an unlimited amount of time. Again, this information may be stored locally on any one or a combination of the thermostats 46 in the home environment 30, or by one or more servers associated with the service 64.

The second option 206 enables the primary user to remove guests for which a profile has been created. The thermostats 46 may simply delete these guests from memory, or may retain the guests and, instead, associate their stored profiles with additional information (e.g., alerts). For example, the primary user may generate a profile for a particular guest for the duration of the guest's stay, and subsequently remove the guest's profile after the guest has left. As another example, in certain embodiments the primary user may have generated a profile for a regularly-scheduled service (e.g., a cleaning service), such as to enable the service to automatically enter the home environment 30 during certain times of the day and to adjust thermostat settings to comfortable levels for the service providers. Should the primary user decide that the service is no longer desired, the primary user may delete the guest profile that is associated with the service such that the providers are no longer able to enter the house or to otherwise make adjustments to the home environment 30. This may also trigger other available settings for the primary user, such as alerts if the service providers attempt to re-enter the home.

The third option 208 enables the primary user to adjust settings associated with a particular guest, resulting in a change in the data associated with a particular guest in the memory of the thermostat 46, or other association by the thermostat 46 and/or the service 64. For example, once the primary user has established a profile for a particular guest, the primary user may subsequently desire to adjust the guest's access, such as to allow the guest to have additional control over the thermostats 46, to automatically enter the home (e.g., via the activation of electronic locks), to generate schedules, and so forth. On the other hand, the primary user may adjust the guest's access such that confirmation is required before the guest is allowed to enter the home or before other adjustments are made to the thermostats 46.

The fourth option 210, as illustrated, enables the primary user to create generic guest profiles—i.e., profiles for guest classes or groups. These settings would also, in certain embodiments, be stored in local memory of the thermostat 46 and/or by the service 64. For example, the primary user may use the fourth option 210 to generate a generic profile for a relative, a friend, a housekeeper, or a similar group. By configuring generic classifications, the primary user may quickly associate identified guests with these profiles, which can greatly increase the likelihood that the primary user will actually associate particular guests with desired settings. In other words, enabling generic classifications can encourage the primary user to configure guest access for guests, which in turn enables the thermostats 46 to efficiently operate the HVAC system 48.

Further, in some embodiments, the primary user may correlate such generic guest profiles with settings and access typically associated with the group. For instance, for a relative, the primary user may enable enhanced settings—such as the ability to generate schedules and to make significant adjustments to one or more thermostats 46. For a friend, the primary user may provide a level of access appropriate for a guest that periodically visits the home, but not for extended periods of time. In this regard, the generic guest profile for a friend may include limitations on schedule setting, temperature adjustment magnitudes, and so forth. For a guest that regularly visits the home, such as a housekeeper or similar service provider, the primary user may enable enhanced levels of access during certain times of particular days of the month. For instance, the settings for a generic service provider guest profile may enable little to no access to the thermostats 46 and/or the home, except for those days when the service provider is expected, such as one day per week, or one day every other week. The access may also be limited to a time, such as between the hours of 10 am and 3 pm. Outside of this timeframe, the service provider might have little to no access to the home and thermostats 46 (e.g., due to the thermostats 46 and/or the home being locked).

Again, generic guest profiles generated in this manner may then be associated with particular guests, which may expedite the configuration process for adding a new user, or for configuring a guest's access on the fly, as discussed below. Indeed, configuring access in this way, either at the thermostat 46 or using remote access devices, enables a large number of guests to be identified and allowed access without having to perform time-consuming configurations for each person. The primary user may also make adjustments to the settings that are imported from a generic profile so as to customize each guest's settings. The thermostats 46 (and other devices 10) may then implement the pre-configured settings associated with the general class of the identified guest.

The generic guest profiles may also be edited using the fifth option 212. For example, in the fifth option 212, the primary user may adjust the settings associated with a particular generic guest profile, such as to change a temperature range in which the generic guest profile allows adjustments, to change a maximum temperature adjustment magnitude, to change a time range during which the generic guest profile is able to make adjustments to thermostats 46 and to access the home, and so on. In certain embodiments, the primary user may also be provided with an option to update the settings associated with guest-specific profiles that were generated by importing the generic guest profile settings (e.g., into the local memory of the thermostat 46). For example, if a particular guest's profile is configured by initially importing settings from a generic guest profile, and the generic guest profile is subsequently changed, the thermostat 46, the webpage 178, or another device (e.g., the primary user's personal electronic device), may provide the primary user with the option to automatically update the particular guest's settings based on this change.

Examples of the settings that can be configured for particular guests (or generic guest groups) are discussed below in the context of adding a guest according to the selection of the first option 204 above. However, it should be noted that the settings discussed hereinbelow are intended to represent settings that can be configured and adjusted according to any of the other options discussed above with respect to FIG. 9. Indeed, the settings adjustments and configurations disclosed herein may be used in any suitable combination to generate a customized profile that is correlated to a particular person (i.e., guest), or a particular group.

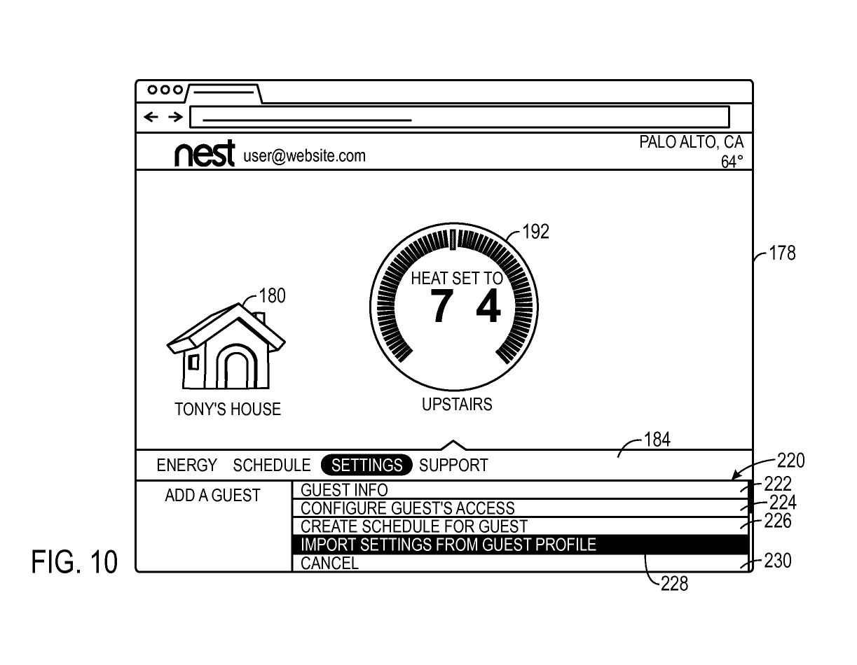

As noted above, the upstairs thermostat icon 192 is selected by the primary user, and the primary user, as shown in FIG. 10, has selected to add a guest in accordance with the first option 204 (FIG. 9). As depicted, the webpage 178 (or other graphical user interface) may present the primary user with a submenu 220 of the first option 204, which includes, by way of non-limiting example, an option to enter guest information 222, an option to configure the guest's access 224, an option to create a schedule for the guest 226, an option to import settings from a generic guest profile 228, and a cancel option 230. Again, other options not explicitly shown may also be provided.

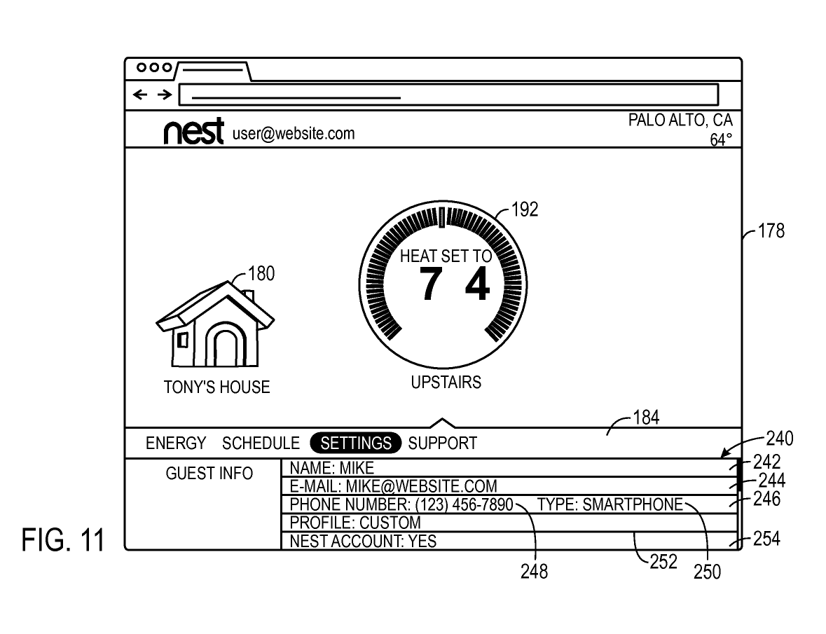

The option to enter guest information 222, as discussed in detail with respect to FIG. 11 below, may enable the primary user to enter various identifying information relating to the particular guest. This information may be stored (e.g., on the thermostat 46 and/or cloud based computer system 64) and compared to data received by the thermostats 46 for performing the guest identification discussed above.

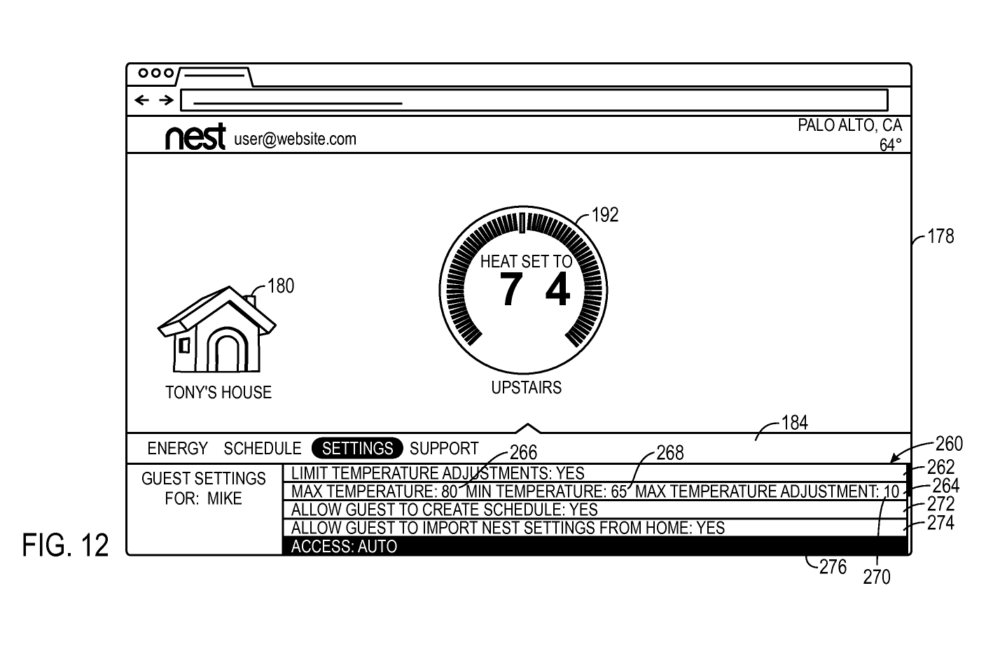

The option to configure the guest's access 224, in a general sense, enables the primary user to allow the guest to make certain types of adjustments to various settings of the home environment 30 within certain constraints defined by the primary user. The guest's level of access may also enable the guest to access the home, receive home alerts, and so on, depending on the particular settings chosen by the primary user. Various configuration options relating to the guest's settings are discussed in further detail below with respect to FIGS. 12-14.

The option to create a schedule for the guest 226 may enable the primary user to enter thermostat settings based on a timeframe in which the guest is visiting the home. Further, the schedule, in certain embodiments, may be regular (e.g., every other weekend for a relative) or irregular (e.g., the primary user creates a schedule for every visit). The schedule set by the primary user for the guest may have the same interface as the interface used to set the primary user's schedule, and/or may have other options. For example, while the interface to generate the schedule may be the same, additional options may be provided to enable the guest to have varying degrees of control over one or more thermostats 46 at different times of the day. For instance, in the morning, the schedule may lock the upstairs thermostat 76 such that the guest is not able to make adjustments to the thermostat's settings (or the available adjustments may be very limited compared to other available adjustments during other times of the day). However, in the afternoon, the schedule may enable the guest to make a greater amount of adjustments to the thermostat 76 compared to the adjustments available in the morning.

A number of such settings may be established based on this schedule. As another example, the schedule may enable the guest to enter the home during a certain timeframe (e.g., between 9 am and 11 am), provided that the guest has been identified or is able to be identified before entering the home. The schedule may also affect other devices 10 of the home environment 30, such as an alarm system. For example, the schedule may coordinate the electronic home locks with the alarm system to automatically de-activate the alarm during the time frame when the guest is able to enter the home. The schedule may also include options to notify the guest if there is a home alert, such as when the alarm system is triggered.

The option to import settings from a generic guest profile 228 may enable the primary user to auto-populate many of the guest's available settings based on a generic guest profile established according to the fourth option 210 discussed above with respect to FIG. 9. The primary user may further customize the guest's settings by first auto-populating the guest's settings entries, followed by adjusting one or more particular settings for the guest as desired.

The primary user may also cancel the operation of adding a guest by selecting the cancel option 230. The menu 220 may also include other options not specifically illustrated, such as options to navigate back to the settings sub-menu 200 (FIG. 9).

When the primary user selects the option to enter guest information 222, a guest information submenu 240 may be presented, an example of which is depicted in FIG. 11. As noted above with respect to FIG. 9, the information provided relating to the guest may be used to identify the guest, for instance to provide automatic access to the thermostat 46. Entering the guest information may also enable the webpage 178 (or other user interface of the thermostat 46) to auto-populate settings entries, schedule entries, desired temperature settings, and so on, based on a comparison between the entered information and information associated with accounts serviced by the cloud-based computing system 64 (or other servicer). Further, in some embodiments, the guest's own account (i.e., the account for which the guest is the primary user) may provide an indication to the guest that the guest has been given guest access to the primary user's system. The guest may also be able to enter identifying information, desired settings, and so forth. Further, the guest may also be given control over whether the guest's desired settings or other identifying information are auto-populated into entries being made by primary users, for example to provide the guest with additional privacy control.

Among other entries, the guest information submenu 240 may enable the primary user to provide a name entry 242, which may be any desired name for the guest. The name entry 242, therefore, may include the guest's full name, a nickname for the guest (e.g., grandma), or a combination thereof. For example, in certain embodiments, the guest information submenu 240 may include options to enter both the full name of the guest and a nickname for the guest that, for example, could be displayed by the thermostat 46 to welcome the guest upon entry/access to the home environment 30. Further, in some embodiments, it may be desirable for the name entry 242 to include the full name of the guest (or as much of the name as possible) to compare the guest's full name to full names associated with accounts serviced by the cloud-based computing system 64 (or other service). In embodiments where the guest's full name corresponds to a serviced account, the webpage 178 may auto-populate the guest's information, which can be confirmed and/or edited by the primary user.

The primary user may also be able to provide one or more e-mail entries 244 and one or more phone entries 246. These entries 244, 246 may be used by the service 64 and/or thermostats 46 not only for identification purposes, but also to send the guest alerts (e.g., alarm alerts, access notifications). For example, as depicted, the phone entry 246 includes both a number entry 248 and a phone type entry 250. In embodiments where the phone type entry 250 indicates that the number entry 248 is the number for the guest's smartphone, the guest may be provided with text messages, notifications, etc., relating to the guest's potential use of the thermostats 46 and/or other devices 10 of the home environment 30. Indeed, in embodiments where the guest does not have an account that is serviced by the cloud-based computing system 64, the cloud-based computing system 64 may enable the guest to create an account for use when the guest enters into various home environments that are controlled by similar systems (e.g., serviced by the same cloud-based computing system). For example, a text message sent to the guest's smartphone may include a link to download an application serviced by the cloud-based computing system 64, which the guest may use to create an account, make remote adjustments to the thermostats 46, and so forth.

In this regard, should the guest eventually own a similar system, the guest already has the account that can be correlated to the new system in which the guest will be a primary user. Additionally, in situations where thermostats (e.g., thermostats 46) belonging to other users have learned from settings adjustments performed by the guest, the cloud-based computing system 64 may generate learning data that can subsequently be used by the guest's own system to establish automatic adjustments (e.g., as in the creation of a settings adjustment schedule).

The guest information submenu 240 also includes a profile entry 252, which in the illustrated embodiment indicates that the guest has a custom profile. However, in other embodiments, the profile entry 252 may indicate a generic guest profile previously created by the primary user, for instance using the fourth option 210 to create a guest profile discussed above with respect to FIG. 9. For example, the profile entry 252 might indicate that the profile is a “friend” profile or a “relative” profile. In certain embodiments, the profile entry 252 may auto-populate based on other entries by the primary user (e.g., based on settings entries for the guest).

The profile entry 252 may, additionally or alternatively, correspond to an active icon that can be selected by the primary user. For example, the profile entry 252 may be a link to other menus for settings configurations, such as to the sub-menu 220, which enables the primary user to associate the guest with a particular profile. In other embodiments, the profile entry 252 may generate a list (e.g., a dropdown box) when selected (e.g., via a mouse click when the cursor is over the profile entry 252, or by a finger tap on a touchscreen, or by an inward click or other button click on the thermostat 46). By way of example, the list may be a list of the generic profiles created by the primary user, each of which can be selected to associate the guest with the selected profile.

As illustrated, the guest information submenu 240 also includes an account entry 254, which enables the primary user to identify whether the guest has an account with the servicer of the cloud-based computing system 64. The account entry 254 may be populated by the primary user, or may be auto-populated based on other entries (e.g., the name entry 242, the e-mail entry 244, the phone entry 246, or a combination thereof). The account entry 242 may also enable guest identification and guest settings to be imported. For example, if the primary user knows that the guest has an account but does not know any particulars about the guest's account, the servicer of the cloud-based computing system 64 may also enable the primary user's system to identify the guest based on certain particulars of the guest's account. In such embodiments, these particulars may not necessarily be provided to the primary user to ensure the security of the guest's account.

The guest information submenu 240 may also enable the primary user to input other identifying information about the guest, including biometric information, height, weight, eye color, and similar identifying information. For instance, in certain embodiments, the guest information submenu 240 may enable the primary user to upload a photograph of the guest to facilitate identification of the guest (e.g., using facial recognition methods) by the thermostats 46 or other devices in communication with the thermostats 46 or otherwise connected to the wireless network. The photographs may be stored locally on the thermostats 46 and/or by the computing system of the service 64.

As noted above with respect to FIG. 10, the guest settings sub-menu 220 may also include the option to configure the guest's access 224, which may include configuring access to the thermostats 46 and/or other devices in the home environment 30. Indeed, in certain embodiments, configuring the guest's access may also include configuring access to the primary user's home (e.g., via electronic locks).

In certain embodiments, the primary user may configure the guest's access to each of the thermostats 46 within the home environment 30, such that there may be different levels of access to the different thermostats 46 in the home. For example, the different levels of access provided to the guest may depend on the location of the thermostat 46 and the overall affect of settings adjustments at the thermostat 46 on the home environment 30. One embodiment of the manner in which the primary user may configure the guest's access is depicted in FIG. 12.

Specifically, the webpage 178 (or other graphical user interface) depicted in FIG. 12 includes an access configuration sub-menu 260, which may include a number of options for controlling the way that the guest is able to interact with the various thermostats 46. In the illustrated embodiment, the access configuration sub-menu 260 may configure access specifically for the upstairs thermostat 76, although a similar interface may be provided for other thermostats 46 within the home, or for the entire home environment 30.

By way of non-limiting example, the access configuration sub-menu 260 may include an option to limit temperature adjustments 262. In the illustrated embodiment, the primary user has elected to limit the temperature adjustments available to the guest. In particular, the primary user may be able to enter temperature adjustment limitations 264, including a maximum temperature limit 266, a minimum temperature limit 268, and a maximum temperature adjustment limit 270.

For example, in the illustrated embodiment, the guest is able to make adjustments to the temperature settings of the upstairs thermostat 76 within a range of between 65 and 80 degrees, and by as much as 10 degrees at a time. As noted above, limiting the amount by which the guest is able to make adjustments to temperature settings may avoid wasting energy. For instance, users will often set a thermostat to a temperature that is much lower than a desired temperature, with the intention of causing the home environment 30 to cool quicker. Similarly, users will often set a thermostat to a temperature that is much higher to heat the home environment 30 quicker. However, such adjustments can be very costly if the user forgets to turn the thermostat to the temperature that is actually desired once the home environment 30 is comfortable. Furthermore, such settings adjustments often do not actually result in the home environment 30 being cooled or heated any faster than would be achieved based on setting the temperature to a setpoint that is actually desired. Therefore, limiting the temperature adjustment magnitude may avoid settings that can introduce inefficiency into the HVAC system's operation.

The guest access configuration sub-menu 260 may further enable the primary user to control whether the guest is able to create a schedule by providing a schedule option 272. For example, the primary user may enable the guest to create a schedule that is constrained to a particular timeframe, such as the time period that the guest will be visiting the home. The scheduling options provided to the guest may be constrained within certain parameters defined by the primary user. For example, the schedule that the guest is able to create may be limited to the maximum and minimum temperatures 266, 268 discussed above, to within a certain pre-defined timeframe set by the primary user, to an extent of change between certain times, or any combination of these and/or other constraints.

The guest settings configuration sub-menu 260 may also provide the primary user with an option to allow the guest to import settings from the guest's account with the servicer of the cloud-based computing system 64. As with the guest's scheduling options, the option for the guest to import home settings may be constrained by other parameters generated by the primary user. For instance, the guest may import their settings from their home account, and, if certain of the temperatures are beyond the bounds of the temperature range set by the primary user in the temperature limitations 264, the guest's settings may be replaced with the maximum or minimum value of the range (whichever is appropriate). For example, if the guest's settings call for the temperature setting of the upstairs thermostat 76 to be adjusted to cool to 60 degrees, the upstairs thermostat 76 may only be adjusted to 65 degrees, which is the minimum temperature setting 268 set by the primary user. The guest settings sub-menu 260 may also enable the primary user to replace these temperatures with a custom temperature.

In this regard, the thermostats 46 may also automatically resolve conflicts between the temperature limitations 264 (or a scheduled temperature set by the primary user) and the guest's preferred settings (e.g., imported settings) by choosing a temperature that is neither the guest's preferred temperature setting nor the nearest end point of the temperature range set by the primary user (or the actual temperature set by the primary user). For example, in certain embodiments (e.g., when allowed by the primary user), the thermostat 76 may run an algorithm that chooses an average of the conflicting temperatures, chooses a weighted sum or average of the conflicting temperatures, prompts the primary user to allow or deny the desired adjustment, or any combination thereof.

The guest's automatic access to each of the thermostats 46 may also be configured, for example by providing a guest access option 276. In a general sense, the guest access option may provide the primary user with various options relating to how the guest is actually able to use the thermostats 46. For example, in the illustrated embodiment, the primary user has indicated that the guest is to automatically be provided with access upon identification. In this way, after the upstairs thermostat 76 identifies the guest (i.e., “Mike,” in the illustrated embodiment), the identified guest is automatically granted access to use and make adjustments to the thermostat 46 in accordance with the settings prescribed by the primary user. In other embodiments, the primary user may select an option that requires the primary user to confirm access for the guest before the guest is provided access (e.g., once the guest is identified). In still other embodiments, the primary user may select an option that requires the guest to input a code (e.g., a personal identification number, a quick response code or a bar code generated by the guest's personal electronic device).

Other settings options may be provided in addition to or in lieu of any of the options discussed above with respect to the guest settings sub-menu 260. For example, the primary user may also enable a learning mode that is specifically correlated to adjustments made by the guest. Therefore, in some embodiments, one or more of the thermostats 46 may automatically generate a settings adjustment schedule based on past settings adjustments made by the guest.

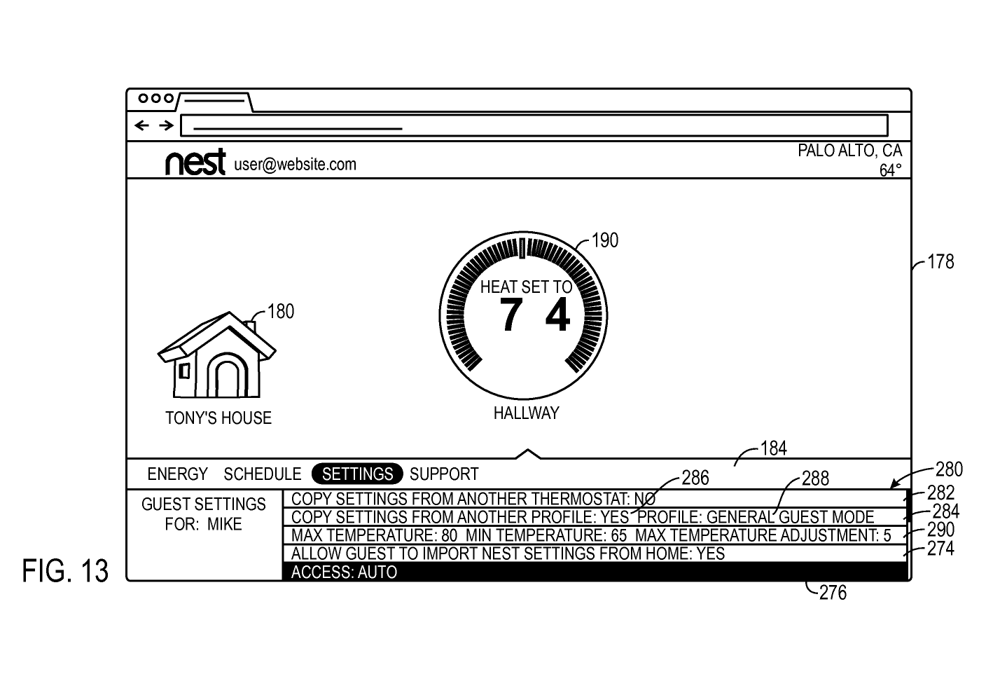

As noted above, each of the thermostats 46 may be separately configured, or configured together in any combination, according to the embodiments described above with respect to FIGS. 8-12. FIG. 13 provides an example interface that enables the primary user to configure certain of the guest's settings for the hallway thermostat, which is represented by the hallway thermostat icon 190. In the illustrated embodiment, the primary user may, for example, wish to limit the guest's available adjustments to the hallway thermostat to a greater extent than the upstairs thermostat.

A settings sub-menu 280 associated with the hallway thermostat may provide the primary user with the same options as set forth above. Other options may also be provided once other thermostats have been configured. By way of example, the settings sub-menu 280 includes a thermostat settings copy option 282, which enables the primary user to copy the settings associated with another thermostat 46 to the selected thermostat 46, e.g., the hallway thermostat. While the illustrated embodiment depicts the primary user as having not copied settings from another thermostat, it should be noted that in embodiments where the primary user does want to copy settings, the webpage 178 (or other configuration page) may present a list or other arrangement of the configured thermostats for selection by the primary user.

A profile settings copy option 284 may also be provided. Therefore, in a general sense, the primary user may associate different thermostats with different generic guest profiles, where each thermostat 46 may have its own associated profile. The primary user may provide a copy settings entry 286, which may be an affirmative or negative entry regarding whether the thermostat 46 should copy settings from a generic guest profile for the guest, and a profile entry 288, which is an entry indicating which generic guest profile should be used. In the illustrated embodiment, the primary user has elected to copy the settings profile of a generic guest mode, which includes a respective set of temperature adjustment limitations 290, which may have the same effect on the operation of the hallway thermostat as the temperature adjustment limitations 264 set for the upstairs thermostat. For the generic guest mode, however, the primary user has constrained the maximum temperature adjustment magnitude to 5 degrees.

In addition to the settings set forth above, the primary user has also denied the guest from importing settings into the hallway thermostat. Such a setting may be desirable, for example, in embodiments where the thermostat may control several areas of the home environment 30. The primary user has further indicated that the guest is to be provided automatic access to the hallway thermostat, for example after the guest is identified.

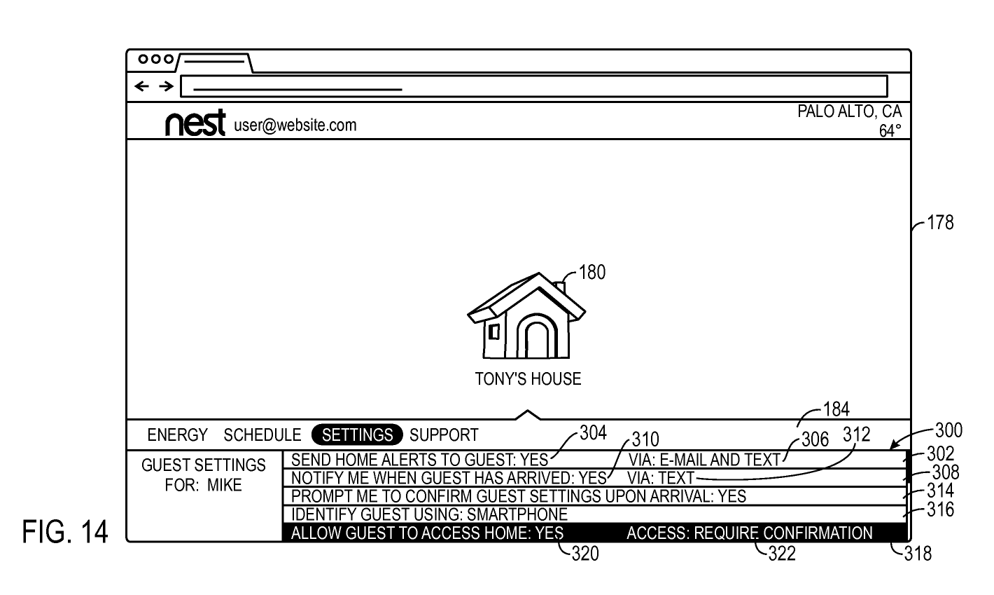

As noted above, the webpage 178, or mobile application (e.g., in embodiments where the primary user configures access on a smartphone or tablet), or the thermostat 46 may enable the primary user to configure access for any one or a combination of the thermostats 46 of the home environment 30. Additionally or alternatively, the primary user may configure access for the whole home environment 30. Such an embodiment is depicted in FIG. 14.

In particular, FIG. 14 depicts an embodiment of the webpage 178 where the primary user has selected settings associated with the home icon 180. For example, the primary user might have first selected (e.g., via a mouse click or a finger tap) the home icon 180, and selected the “SETTINGS” option in the menu 184. The illustrated embodiment of the webpage 178 includes a home settings sub-menu 300, where the primary user is able to configure options for the guest relating to a number of home environment options.

The home environment options of the home settings sub-menu 300 may include a home alerts option 302, which may enable the primary user to allow the guest to receive home alerts relating to potential emergency situations. For example, one or more of the thermostats 46, or another device 10 such as an alarm device that is in communication with the thermostats 46, may receive an input indicative of a potential emergency situation. Such an input might include a signal from a door or window sensor that an unauthorized entry into the home environment 30 has occurred. Other inputs may include an input indicative of smoke and/or carbon monoxide (e.g., as in a potential fire situation), a leak in the plumbing system of the home environment 30, or, in some embodiments, signals received from a home health monitoring service that indicate a potential health emergency situation of one of the occupants (e.g., primary users) of the home.

The home alert option 300, as depicted, may include a notice entry 304, which indicates whether the thermostat 46 (or the cloud-based computing system 64) should notify the guest. As noted above with respect to FIG. 10, the home alerts may, in some embodiments, be limited to a schedule created by the primary user (or, in other embodiments, by the guest) such that the guest only receives home alerts within a predetermined time frame.

The home alerts option 302 may also include an alert method entry 306, which indicates the method by which the thermostat 46 and/or the cloud-based computing system 64 should notify the guest of a home alert. As depicted, the alert method entry 306 indicates that the guest should be notified by text message and e-mail, for example using the phone number and e-mail address provided in the webpage embodiment of FIG. 11 relating to guest information. Other alert methods may be provided, such as smartphone notifications, an automated phone call, or the like. In this way, should an alert situation arise, the thermostat 46 and/or other devices 10 may cause the service 64 or other services, to send such notifications.

The home alerts may be desirable, for example, in situations where the primary user might be away from the home environment 30 for an extended period of time and does not have ready access to the home. For example, the primary user may be on vacation or a business trip. In this way, the primary user is able to provide the guest with notifications should any potential home emergency situations arise so that the guest is able to check on the home. As discussed below, the primary user may also enable the guest to have automatic access into the home environment 30, for example using electronic locks.

The home settings sub-menu 300 may also include an arrival notification option 308, which enables the primary user to receive a notification when the guest has arrived at the home. By way of example, the thermostats 46 (or other devices in communication with the thermostats 46) may detect the guest (e.g., based on smartphone signal strength, based on an arrival notification from a smart vehicle, based on biometric recognition), and may send a notification to the primary user that the guest has arrived at the home. Such detection may be desirable, for instance, to enable the primary user to remotely allow the guest access to the home environment 30 without having to be at the door, or without even having to be in the home.

The arrival notification option 308 includes a notification entry 310, which indicates that the primary user should be notified when the guest arrives at the home, and an arrival notification method entry 312, which indicates the method that the thermostats 46 and/or the cloud-based computing system 64 should use to notify the primary user of the guest's arrival. In the illustrated embodiment, the primary user has elected to be notified by text message. The thermostats 46 and/or the service 64 or other services would then, upon arrival of the guest, cause the primary user to be notified. Other notification options may include, by way of non-limiting example, smartphone notifications, notifications on a television connected to the wireless network, notifications provided by e-mail, notifications provided by an automated phone call, a text message, and the like. In some embodiments, the notification provided to the primary user may also have a link to a series of options relating to the guest's arrival, such as an option to allow the guest to enter the home environment 30, an option to confirm the guest's guest mode settings, or a combination of these and other similar options.

Indeed, as set forth in the home settings sub-menu 300, a confirmation option 314 is provided to enable the primary user to require that the thermostat 46 (or cloud-based computing service 64) cause a prompt to be provided to the primary user (e.g., at the thermostat 46 and/or on the personal electronic device 70) to confirm the guest's settings. By way of example, the thermostat 46 may first cause the primary user's smartphone to provide a notification that the guest has arrived at the home. When the primary user clicks or touches the notification (e.g., an icon on the smartphone), a mobile application may open that enables the primary user to allow, deny, or configure the guest's settings/access for the whole home environment 30 and/or individual thermostats.

The primary user may also, in certain embodiments, define the method used to identify the guest using an identification option 316. In the illustrated embodiment, the primary user has elected to have the thermostats 46 (or other devices 10) identify the guest based on the guest's smartphone. For example, the thermostats 46 may identify the guest based on a smartphone signature, a phone number of the smartphone, a mobile application on the guest's smartphone, or any combination thereof. Other identification methods may be provided to the guest, as discussed above. Indeed, the primary user may select any one or a combination of appropriate methods (e.g., smart device data, biometric data, gait analysis, code input).

In addition to or in lieu of the settings associated with making adjustments to the home environment 30, the home settings sub-menu 300 may provide a home access option 318 that enables the guest to enter the home. For example, upon identifying the guest, the thermostats 46 of the home environment 30 may cause the home's electronic locks to disengage to enable the guest to enter the home. In the illustrated embodiment, the home access option 318 includes a guest access entry 320 and an access type entry 322.

By way of non-limiting example, the access type entry 322 may indicate the type of entry that is currently available to the guest. The access type entry 322 may indicate that the guest has automatic access such that upon identification, the guest may automatically enter the home without any inputs being needed from the primary user. In the illustrated embodiment, the primary user has provided the access type entry 322 as “REQUIRE CONFIRMATION,” indicating that the primary user must first confirm the guest's access before the guest is granted access into the home environment 30. These settings may all be stored locally on the thermostat 46 and implemented by the thermostat 46 and/or associated automated devices 10.

It should be noted that the options discussed above may be provided as a part of any menu, and in any combination, and are not intended to be limited to being grouped in the manner presented or to being presented as a part of the submenus illustrated. Rather, the options presented above are intended to cover any embodiment in which these and similar options are presented, whether on a computer, a smartphone, a tablet, a portable music device, a television, a refrigerator screen, or any one or a combination of the thermostats 46. Furthermore, the options and associated user inputs may be stored and implemented using the thermostats 46, either alone or in combination with the cloud-based computing system 64 and/or other devices 10 in the home environment 30.

As set forth above with respect to FIGS. 5 and 6, the guest may be provided access to the thermostats 46 automatically, or after a confirmation by the primary user. Indeed, as set forth in the access type entry 322 of FIG. 14, in some embodiments, the primary user may be provided with a prompt on a smartphone, tablet, or the like, to allow, deny, or configure/re-configure the guest's access. Again, the webpages 178 discussed above may correspond to embodiments of a mobile interface presented, for example, on a smartphone of the primary user, or on a graphical user interface of the thermostat 46. Discussed below are further examples of the manner in which the primary user may use a mobile device, such as a smartphone, to configure guest access (e.g., on the fly). Such configurations may be performed at the same thermostat 46 that identified the guest, or on a different thermostat 46 (e.g., mounted to a wall of the primary user's bedroom).

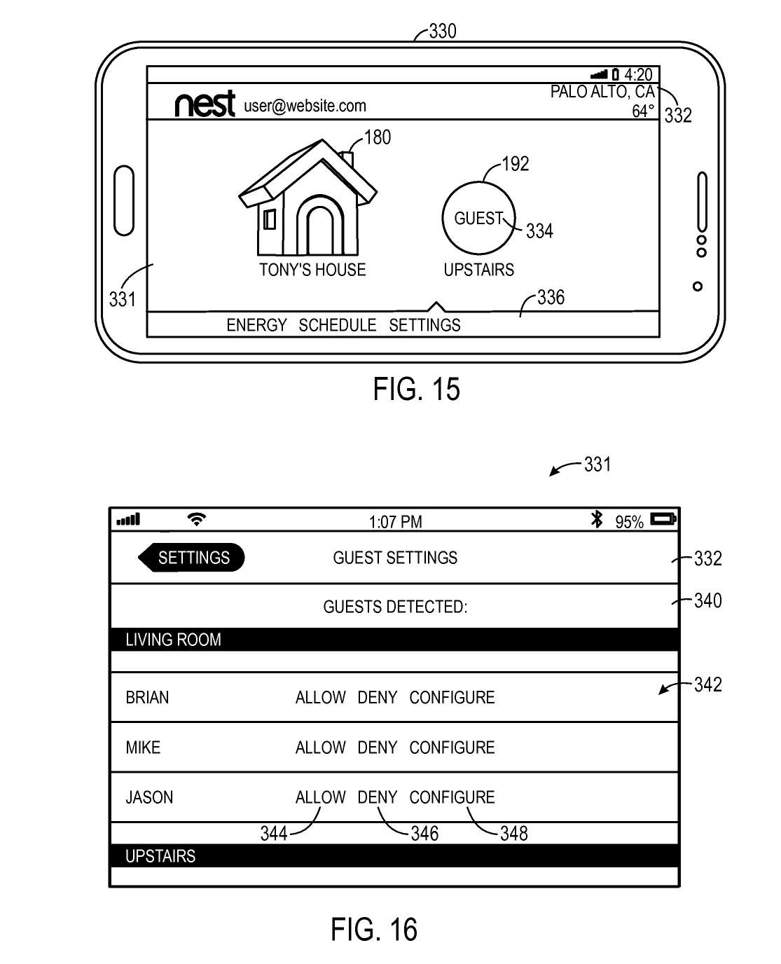

FIG. 15 depicts an embodiment of a smartphone 330 having a touchscreen display 331 that enables interaction with a mobile application's graphical user interface 332. The mobile interface 332, in a general sense, is configured to allow the primary user to adjust settings associated with the home environment 30 and/or individual thermostats 46 in the home environment 30. By way of example, the mobile interface 332 may be generated by a mobile application running on the primary user's smartphone 330 after one or more guests are detected/identified within the home environment 30. However, it should be appreciated that the embodiments described herein may also be provided in the context of a primary user simply configuring guest access on a mobile device, regardless of whether one or more guests have been detected. In other words, the interfaces described below may be used to perform the primary user's acts of FIG. 5 and/or FIG. 6. Indeed, the options described below are also intended to be applicable to the webpage embodiments discussed above, as well as the interface of the thermostats 46. Generally, the actions set forth below may cause the mobile application to send appropriate instructions and other information to the thermostats 46 that may be stored in a memory of the thermostats 46 for implementation of the desired settings as appropriate (e.g., using the processing devices 20).

In the illustrated embodiment, the mobile interface 332 includes the home icon 180, which represents the home environment 30, and the upstairs thermostat icon 192, which represents the upstairs thermostat 76. However, rather than simply depicting a set temperature of the upstairs thermostat 76, the upstairs thermostat icon 192 has a guest indication 334, which notifies the primary user that the upstairs thermostat 76 has detected one or more guests or is already in a guest mode. To configure guest settings for the identified guests, the primary user may, for example, touch the upstairs thermostat icon 192 (or the home icon 180), and then touch a “SETTINGS” option on a main menu 336 of the mobile interface 332.

The mobile interface 332, as depicted in FIG. 16, may provide a guest list 340 of guests that have been identified. The guest list 340 may be grouped according to any suitable method, including grouping based on the identified guests' profiles, based on the thermostats 46 that have detected the guests, or any similar grouping. As illustrated, the guests in guest list 340 are grouped based on thermostats 46 within the home. As depicted, a living room thermostat has detected several guests based on respective identifying inputs, and each of the guests has separately listed settings options 342, which may be selected by the primary user to configure the settings for each of the listed guests. The settings options 342 are depicted as including an allow option 344, a deny option 346, and a configure option 348, though other options may additionally or alternatively be provided.

The allow option 344 may enable the primary user to allow the listed guest to have access to the thermostat 46 under which the guest is listed. For example, selecting “ALLOW” for Brian enables Brian to have access to the living room thermostat. If settings have already been configured for Brian, Brian may be granted access to the thermostat according to the configured settings. As an example, if the settings are stored on the living room thermostat, the thermostat may simply implement the settings. However, if the settings are stored on another thermostat of the home environment 30 and/or on the cloud-based computing system 46, then the living room thermostat may import these settings. However, if settings have not yet been configured for Brian, the mobile interface 332 may provide a warning that allowing Brian to have access to the living room thermostat will give Brian full privileges. In other embodiments, the primary user may first create a rule that allowing a guest access to a thermostat 46 when the guest's settings have not been configured automatically associates the guest with a generic guest mode profile (or other desired profile). In such an embodiment, selecting “ALLOW” for Brian would automatically associate Brian with a generic guest profile and allow Brian to make adjustments to the living room thermostat in accordance with the settings of the generic guest profile (e.g., a friend profile).

On the other hand, selecting “DENY” for one of the guests may prevent the guest from making any adjustments to the listed thermostat, or may limit adjustments available to the guest at that thermostat according to a rule defined by the primary user. For example, selecting “DENY” for Jason may prevent Jason from making any adjustments to the living room thermostat. In other embodiments, selecting “DENY” for Jason may enable Jason to make adjustments according to the lock settings that the primary user has defined for the living room thermostat. For example, settings adjustments available to Jason at the living room thermostat may be limited to a small temperature range (e.g., a few degrees), such as settings adjustments that are similar to those allowed in the locked mode discussed above with respect to FIG. 3.

In situations where the primary user wants to configure or re-configure access for one of the listed guests, the primary user may select the “CONFIGURE” option associated with the particular guest. The primary user may also configure settings associated with other thermostats 46 by, for example, navigating down through the list by holding a finger on the touchscreen display 331 and dragging the finger down. Additionally, the primary user may hold a finger on the guest's name, and the mobile interface 332 may provide a pop-up display of settings associated with the listed guest. For example, holding a finger on “MIKE” may produce a pop-up display indicating that Mike has a custom profile for the living room thermostat. In this way, the primary user may be able to check the guest's access before allowing, denying, or re-configuring the guest's access.

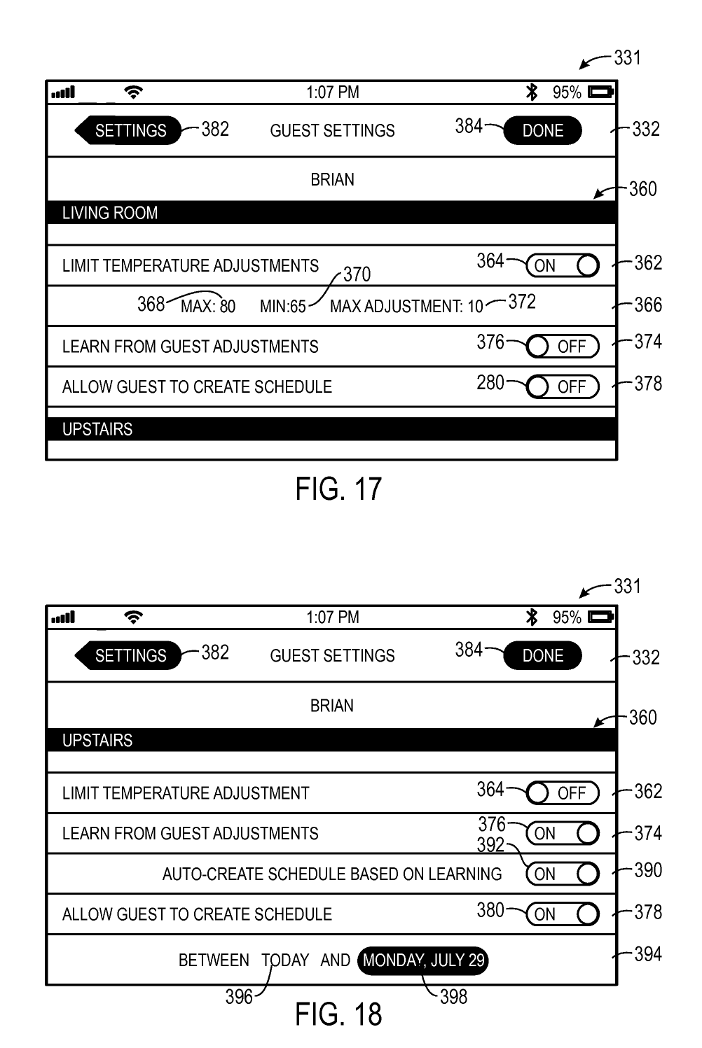

The mobile interface 332 may provide settings options to the primary user in a manner that enables the primary user to quickly enter and configure settings, which are then transmitted to the thermostats 46 for implementation. One example of an embodiment of a configuration interface 360 for the guest “BRIAN” is depicted in FIG. 17. In particular, the mobile interface 332 includes the configuration interface 360 grouped for the guest according to each thermostat. The options presented in FIG. 17 relate to the living room thermostat. However, the primary user may also configure the guest's access to other thermostats 46 (e.g., the upstairs thermostat 76), as shown.

The configuration interface 360 may include a temperature adjustment limit option 362, which may be similar to the option 262 described above with respect to FIG. 12. While any selection method may be employed, the illustrated embodiment includes a temperature limit OFF/ON button 364 associated with the temperature adjustment limit option 362, which the primary user may touch to move the selection between “OFF” and “ON.” In embodiments where the temperature limit OFF/ON button 364 is set to “OFF,” the thermostat 46 will not limit the guest's temperature adjustments, while if it is set to “ON,” the thermostat 46 will limit the guest's temperature adjustments to a defined range and adjustment magnitude.

Indeed, in the illustrated embodiment, the primary user has elected to limit the temperature adjustments available to Brian at the living room thermostat by setting specific temperature limitations 366, which may be stored by the thermostats 46 for future implementation. The temperature limitations 366, as illustrated, limit Brian's allowable temperature adjustments to a maximum temperature 368 of 80 degrees and a minimum temperature 370 of 65 degrees, with an adjustment magnitude limit 372 of 10 degrees by setting the temperature limit OFF/ON button 364 to “ON” and entering the desired temperature limitations 366. For example, selecting any one of the temperature limitations 366 may produce an additional interface for value selection, such as a scroll/wheel.

The configuration interface 360 may also include a guest learning option 374, which may enable the thermostat 46 to learn from the guest's adjustments. By way of example, the guest learning option 374 may include a guest learning OFF/ON button 376, which may be toggled by the primary user. In the illustrated embodiment, the primary user has elected to prevent the living room thermostat from learning from Brian's adjustments. In such embodiments, the thermostats 46 may stop learning, or may continue learning but not make adjustments to established temperature schedules. In this way, the thermostats 46 continue to receive inputs related to the operation of the HVAC system and the home environment 30, but do not make aggressive changes to various schedule settings.

A guest schedule creation option 378 may also be provided to enable the guest to create a schedule on the thermostats 46. Like the options discussed above, the guest schedule creation option 378 may be allowed or denied using a guest schedule OFF/ON button 380, and toggling the button 380 between “OFF” and “ON.” As mentioned above, any selection method may be employed in addition to or in lieu of the OFF/ON buttons. For example, the various options presented in the configuration interface 360 may be allowed or denied using radio-based selections, textual entries, list-based entries, and the like.

The primary user may also configure guest settings for other thermostats by, for example, navigating back to the mobile interface 332 presented in FIG. 16 using one or more navigation buttons 382. The primary user may also select a “DONE” button 384 to indicate that configuration has been completed for the particular guest and, in certain embodiments, for the particular thermostat 46. Additionally or alternatively, the primary user may scroll through the configuration interface 360 to be presented with settings options for the other thermostats 46.

FIG. 18 depicts an example of the configuration interface 360 where the primary user is able to configure access for one of the guests (e.g., Brian) for the upstairs thermostat 76. The primary user, in the illustrated embodiment, has elected to provide Brian with greater access to the upstairs thermostat 76 compared to the living room thermostat. For example, having the temperature limit OFF/ON button 364 set to “OFF” turns off the temperature adjustment limit option 362. Accordingly, Brian may make any desired temperature adjustments to the upstairs thermostat 76. As illustrated, the temperature limitations 366 may not be shown (e.g., may be collapsed) when temperature adjustments are not limited.

The guest learning option 374 is also activated, as indicated by the guest learning OFF/ON button 376 being in the “ON” position. In embodiments where the primary user enables the particular thermostat 46 to learn from guest adjustments, the thermostat 46 may also be able to auto-create a schedule based on the learned guest adjustments. Accordingly, the configuration interface 360 may also include an auto-scheduling option 390, which may be activated and de-activated using an auto-schedule OFF/ON button 392. In the illustrated embodiment, the primary user has enabled the upstairs thermostat 76 to auto-generate a schedule based on learning from Brian's adjustments to the upstairs thermostat 76 over time. This scheduling may also be determined by Brian's adjustments to other thermostats 46 in the home environment 30, or may be limited to the adjustments to the upstairs thermostat 76.

The primary user has also enabled the guest (i.e., Brian) to create a schedule on the upstairs thermostat 76 by toggling the guest schedule OFF/ON button 380 to the “ON” position. In embodiments where the primary user enables the guest to generate a schedule, the configuration interface 360 may present the primary user with a timeframe option 394 to limit the timeframe in which the guest is able to generate a schedule.

For example, the timeframe option 394 may include a start date entry 396 and an end date entry 398, which may be independently populated according to selections by the primary user. For example, in embodiments where the primary user places a finger over the start date and/or end date entries 396, 398, a calendar, date list, or other selectable presentation of dates may be displayed. The primary user may select a desired start date and end date, which defines a time frame during which the guest is able to create a schedule. Accordingly, the upstairs thermostat 76 would allow Brian to generate a schedule that is implemented during the timeframe. Further, in embodiments where the primary user limits the temperature settings, the temperature settings available for the guest's scheduling may be limited to the minimum and maximum temperature entries 370, 368 defined by the primary user. An example guest schedule sequence 410 presented to a guest (e.g., Brian) by interacting with the one of the thermostats 46 (e.g., the upstairs thermostat 76) is depicted in FIG. 19.

As illustrated, the guest schedule sequence 410 provided by the thermostat 46 may include a transition 412 between a current temperature display 414 and a schedule display 416, for example after the guest has selected a scheduling option from a menu of the thermostat 46. The thermostat 46 may then present the guest with the schedule display 416 to enable the guest to select a time, and a temperature setting for the selected time. The schedule display 416 may also present the guest with an indication 418 that the schedule setting is a guest schedule corresponding to the guest's profile.

Once the guest has reached a time at which the guest wants to set a temperature, the guest may select the time (e.g., via an inward click on the thermostat 46). The thermostat 46 may then display a temperature setting screen 420, which may enable the guest to set a temperature. As illustrated, the temperature setting screen 420 shows that a current set temperature 422 for the selected time (e.g., 3 PM) is 72 degrees. The temperature setting screen 420 may enable the user to adjust the set temperature 422 up and down, for example between an upper temperature threshold 424 and a lower temperature threshold 426. In certain embodiments, the upper and lower temperature thresholds 424, 426 may correspond to temperature limitations set by the primary user.

Once the guest has set the temperature for the selected time, the guest may continue to navigate through the schedule display 416, for example by turning an outer ring of the thermostat 46 in a clockwise direction. As discussed above with respect to FIG. 18, in some embodiments, the primary user may also limit the guest scheduling to a particular timeframe, for example to the duration of the guest's stay. Accordingly, the schedule display 416 may also include an unavailable section 428. The unavailable section 428 may provide a visual indication that a particular timeframe is unavailable for scheduling. Indeed, should the guest continue to navigate forward in time (e.g., scroll forward), the thermostat 46 may provide a textual indication 430 (or other visual indication) to the guest that the particular timeframe is unavailable for guest scheduling, or no further scrolling may be displayed.

The guest may navigate back to the schedule display 416, and may make additional temperature settings as desired (e.g., by selecting additional times). After the guest has generated their desired settings, the guest may indicate that the scheduling is complete to navigate back to the current temperature display 414.

The guest mode settings created by the primary user may enable many similar settings adjustments to the thermostats 46 or other home electronic devices. Indeed, not only do the guest mode settings enable the primary user to control guest adjustments to the thermostats 46, but the guest may also feel comfortable interacting with the thermostats 46 because the primary user has specifically created a profile for them. Furthermore, because the preferred settings of the guest may be specifically correlated to the guest, the guest's preferred settings may be preserved for later use (e.g., by being stored in a local storage medium of the thermostat 46 and/or by the cloud-based computing system 64).

The thermostat 46 can also learn from these adjustments, for example to specifically correlate settings to particular guests, and also to learn about the types of adjustments that may occur when a guest is visiting the home. In this way, the thermostat 46 may learn, in a more general sense, about the activity and settings of guests in the home so as to enable the thermostat 46 to automatically make adjustments based on whether guests might be present within the home. Such embodiments are described in further detail below.

C. Guest Mode Initiation Based on Use

As set forth above with respect to FIGS. 5 and 6, guests may be provided access to the thermostats 46 automatically, for example after the thermostats 46 have detected and identified particular guests for which the primary user has created a profile. Again, the guest identification may be based on a variety of received data, including device data (e.g., a smartphone signature), biometric data, gait analysis data, scheduling by the primary user, or the like. However, the thermostats 46 may not always be able to perform such detection. For example, the guest may have forgotten their personal electronic device that would have been used for identification. In other embodiments, the primary user might not have created a profile for a particular guest.

Because the thermostats 46 may perform various analyses to learn from guest adjustments, the thermostats 46 may also determine whether particular adjustments might be indicative of the presence of a guest. For example, the thermostat 46 may learn from the guest schedule set by Brain in FIG. 19 in order to determine whether future adjustments are indicative of whether Brian may be present in the home. FIG. 20 depicts a general method 440 that may be performed by the thermostats 46 to automatically detect guests based on use of the thermostats 46.

The method 440 may include, among other things, receiving (block 442) a request for a settings adjustment. The settings adjustment may be a requested temperature adjustment, a requested schedule creation, or the like. Further, the acts represented by block 442 are not limited to a single thermostat 46. Rather, in embodiments where there are multiple thermostats 46 within the home environment 30, the thermostats 46 may communicate with one another to keep track of adjustments.

Upon receiving the request for the settings adjustment, the thermostat 46 may compare (block 444) the settings adjustment with historical trends of similar adjustments (e.g., temperature adjustments, schedule adjustments). The historical trends may be temperature adjustment trends based on time or another parameter (e.g., weather), schedule creation trends based on timeframe (e.g., schedule creations two days out of every month), and the like. If the thermostat 46 determines that the settings adjustment is indicative of the presence of a guest, the thermostat 46 (or more than one of the thermostats 46) may automatically enter (block 446) into a guest mode of operation.

For example, the acts represented by block 446 may include entering into a generic guest mode of operation when the settings adjustment is indicative of the presence of a guest, but the thermostat is unable to resolve the identity of the guest based on the adjustment and/or other identifying parameters. In certain embodiments, the thermostat 46 may prompt the guest for an input (e.g., a personalized code and/or a name) to enable the thermostat 46 to not only learn from the adjustment, but also tie the settings adjustment to the particular guest. Accordingly, if future adjustments are made in a similar manner, the thermostat 46 may enter into a guest mode of operation that is specific to the particular guest.

Alternatively, the thermostat 46 may resolve the identity of the guest, for example based on biometric analysis, gait analysis, facial recognition, or the like, in combination with the settings adjustment. In such embodiments, if the primary user has created a profile for the identified guest, the thermostat 46 may initiate the guest mode of operation that is specific to that guest.

D. Code-Based Access Control

As discussed above, guests may be automatically identified based on a wide variety of data. Additionally or alternatively, guests may be associated with particular codes, such as personal identification numbers, bar codes, quick response (QR codes), and the like. The thermostats 46 (or other devices 10) may therefore use automatic identification, code-based identification, or a combination thereof, to identify a guest. Furthermore, a guest may first be granted access to thermostats 46 and other devices 10 upon being identified, but may still be required to input a code in order to make adjustments. Such embodiments are discussed in detail below with respect to FIG. 21.

In particular, FIG. 21 represents a generic method 450 for controlling access to an electronically-controlled home environment. Thus, the method 450 may be performed by the thermostats 46, either alone or in combination with other devices including electronic locks, alarms, sensors, and the like. In the illustrated embodiment, the method 450 includes receiving (block 452) an input from a primary user to enable controlled access to the home environment 30. For example, access may be controlled to certain home functions such as lighting, heating and cooling, door locks, alarm systems, and the like. The input may also be guest-specific. That is, the primary user may create a rule that only certain guests are allowed the controlled access.

Once the input is received and processed, the method 450 includes locking (block 454) the electronic home functions. For example, the acts represented by block 454 may include placing the thermostats 46 into a locked mode or a generic guest mode. Additionally or alternatively, the acts represented by block 454 may include locking the electronic locks of the entry door to the home, locking light controls, locking refrigeration controls, locking television controls, or locking any combination of these and other features.

The home environment 30 may maintain the electronic functions in a locked mode until the primary user or an authorized guest unlocks the functions. For example, the method 450 may also include receiving (block 456) a request to access and/or adjust an electronic home function. For example, one of the thermostats 46 may receive a request to change a temperature setting or create a schedule. Additionally or alternatively, the electronic locks of the home may receive a request to unlock to enable access to the home.

Upon receiving the request, the method 450 includes prompting (block 458) the requestor for an unlock input. For example, the thermostat 46 may display an unlock code input screen where the requestor (e.g., the primary user and/or a guest) is able to input an identifying code. Additionally or alternatively, the acts represented by block 458 may include sending the request for the unlock input to a personal electronic device of the requestor, if the thermostat 46 (or other device 10) has been able to identify the requestor.

Upon receipt of the unlock input, the thermostat 46 or other device 10 may determine (query 460) whether the unlock input corresponds to an input associated with the primary user or the guests that were previously authorized by the primary user. In embodiments where the unlock input is not recognized, the method 450 may include maintaining (block 462) the home in a locked mode. For example, the electronic locks of the home may remain locked, and/or the thermostat 46 may not adjust its temperature settings.

In embodiments where the unlock input is recognized, the method 450 may include granting (block 464) controlled access to the electronic home in accordance with the profile corresponding to the unlock code. For example, in embodiments where the unlock code corresponds to a guest having an established profile created by the primary user, the guest may be granted access to the electronic home in accordance with the established profile. For instance, the thermostats 46 may enable the guest to make adjustments according to the guest mode associated with the guest. In some embodiments, this may include automatically updating the operation of one or more of the thermostats 46 to accord with the preferred settings of the guest.

The method 450 may also include providing (block 466) an indication regarding the guest's access. For example, a text or other message may be sent to the primary user and/or to the guest. In embodiments where the access is granted at one of the thermostats 46 (or another device having a display), the thermostat 46 may display a welcome screen to the guest.

III. Real-Time Access Control

It should be noted that the embodiments described above may relate to situations where the primary user configures access for guest users based on a generic operational mode, or based on settings tied to particular guests. While such configurations may be desirable for a number of reasons, including enhancing guest control for certain guests visiting the home, a primary user may want to have control over all adjustments (or certain types of adjustments) made to a home device such as the thermostats 46. Accordingly, the present disclosure is also intended to encompass embodiments where the primary user is prompted when adjustments are made to various device settings (e.g., temperature settings on a thermostat 46), regardless of whether or not the guest that is requesting the adjustment has been identified, has an established profile, and so forth. FIG. 22 depicts an embodiment of a method 470 for enabling the primary user to control certain adjustments made to home devices.

It should be noted that prior to performing the acts set forth below, the primary user may have enabled a specific mode in which the thermostat 46 (or other device) does not allow any adjustments (or only allows certain types of adjustments) without the real-time authorization of the primary user. Accordingly, when performed, the method 470, as depicted, may include receiving (block 472) a request for a settings adjustment or other access by the guest. For example, the request may include a request to change a temperature setting on one of the thermostats 46, or may include a request to unlock electronic locks on an entry door of the home environment 30. In some embodiments, the request may be an automatic electronic request sent by a personal electronic device of the guest (e.g., a mobile application on a smartphone of the guest), which may request that the guest be provided with access to make certain adjustments to various devices (e.g., thermostats 46) within the home environment 30. Further, while the request may be an active request (i.e., initiated by the guest or the guest's device), in other embodiments, the request may be a passive request that is internally generated by the thermostat 46 in an attempt to resolve a level of access associated with the guest (e.g., if the guest is identified).

The method 470 may also include prompting (block 474) the primary user regarding the adjustment/access request. By way of non-limiting example, the prompt may include an electronic message such as a text message, an e-mail, a notification, or the like, on a personal electronic device of the primary user. The prompt may allow the primary user to allow or deny individual adjustments, to allow, deny, or configure access for the guest (e.g., in embodiments where the guest has been identified), or any combination thereof.

By way of example, the request may be a request to lower a temperature setting of the thermostat 46. The prompt may, therefore, ask the primary user whether the temperature adjustment should be allowed or denied. In this way, the primary user has control over individual adjustments. In other embodiments, the request may be a request for guest access in which the guest is allowed to make certain adjustments without input from the primary user. In such embodiments, the prompt may ask the primary user whether the identified guest should be provided with such guest access. The prompt may also provide the primary user with an option to configure the guest's access according to the configuration settings discussed above.

The method 470 may also include determining (block 476), based on the primary user's feedback to the prompt, whether the adjustment/access is allowed. In embodiments where the primary user does not allow the adjustment/access, the method 470 may include maintaining (block 478) the current settings associated with the device. For example, when the request is an adjustment to a temperature setting of a thermostat 46, the thermostat 46 may maintain the current temperature setting, and may provide feedback to the requestor that the adjustment is not allowed or that the thermostat is locked. When the request is a request for guest level access, if the primary user denies guest access, guest settings may simply be disabled for the requestor.

In embodiments where the primary user allows the adjustment/access, the method 470 may include adjusting (block 480) the settings of the device according to the request. For example, when the request is a request to adjust a temperature setting on the thermostat 46, the thermostat 46 may be set to the requested temperature. Higher-level settings adjustments may also be requested and allowed. For example, the request may be a request to import settings from the guest's preferences associated with a home account of the guest (e.g., an account with the same cloud-based computing system 64 as the primary user) into one or more of the thermostats 46. When the primary user allows the request, one or more thermostats 46 may override current primary user or other user settings (including established schedules) to implement the guest's settings.

It should also be noted that, in implementing these settings, the thermostats 46 may utilize a thermal profile of the primary user's home to suitably adjust the operational parameters of the HVAC system 48. In this way, mis-matches between the guest's home system and the primary user's home system will not affect the actual temperature set points that are achieved by the HVAC system 48, such as set points for a schedule. For example, if the guest's preferred schedule calls for the home to be cooler by 5 degrees at a desired time and the guest's home HVAC system takes 15 minutes to cool the guest's home by 5 degrees, the guest's thermostats may cause the guest's HVAC system to begin cooling 15 minutes before the desired time, such that the desired temperature is reached at the desired time. On the other hand, if the primary user's HVAC system 48 takes 5 minutes for the same adjustment, the thermostats 46, in implementing the guest's preferred settings, may cause the HVAC system 48 to operate for the 5 minutes before the desired time so that the temperature is 5 degrees cooler by the desired time.

IV. Vacation Settings

The primary user of the thermostats, when the controlled environment is a single-family home, will generally be a resident of the home, such as the homeowner or other resident of the home. However, in embodiments where the environment is a vacation home that is maintained by a landlord, the primary user may be the landlord or similar entity. The primary user, in such situations, may want for guests to be able to set schedules and make adjustment within predetermined time periods. In accordance with present embodiments, as discussed above with respect to FIG. 10, the primary user may set a guest schedule that enables vacationing guests to have a certain level of access to make adjustments to the thermostats. An embodiment of a method 500 for implementing vacation settings is depicted in FIG. 23. The method 500 may be performed by one or more of the thermostats 46, either alone or in combination with other devices that may be configured to control other aspects of the controlled environment (e.g., locks, televisions).

As illustrated, the method 500 may include automatically granting (block 502) guest-level access for the vacationing guest. Indeed, because the vacationing guests are the only people that are present within the controlled environment, it may be desirable to grant all guests substantially equal access. The guest access may be generated, for example, according to any one or a combination of the embodiments set forth above with respect to FIGS. 8 to 18.

The method 500 may also include identifying (block 504) the guest. While the guest may be identified using any of the methods set forth above (e.g., based on code inputs, based on biometrics, based on gait analysis, based on data received from a smart device, based on adjustment analysis, based on a schedule indicating that the guest will be arriving on a certain day), in some embodiments, the vacationing guest may also be identified based on entries from a clerk (e.g., an attendant of the vacation home), or entries from the guest.

The method 500 may also include determining (block 506) whether the guest has vacation settings tied to the location of the vacation home or hotel. For example, the thermostats 46 may compare the identity of the guest (e.g., identifying information) with a database of account information stored on the cloud-based computing system 64. It should be noted that the vacation settings do not necessarily need to be associated with the particular vacation home/hotel. Rather, the vacation settings may be associated with the general location of the vacation home/hotel (e.g., the city), with a general climate of the vacation locale (e.g., tropical, dry, moderate, continental, polar), or a similar other parameter relating to the vacation home/hotel.

In embodiments where the guest does have vacation settings that may be correlated to the vacation locale, the thermostats 46 may import (block 508) the appropriate settings and implement the guest's preferred settings. Indeed, even if the guest does not have any vacation settings established, in some embodiments, the thermostats 46 may utilize the guest's home settings that can be correlated in some way with the vacation home/hotel. For example, if the vacation locale is warm, the thermostats may utilize the guest's preferred settings learned from adjustments made in the guest's home environment during the summer. If the vacation locale is cold, the thermostats may similarly use the guest's settings from the wintertime.

In embodiments where the guest does not have vacation settings (or when the settings are not extrapolated as set forth above), the method 500 may include using (block 510) default guest settings, which may enable the guest to make settings adjustments and, in some embodiments, create schedules for the duration of the guest's stay (block 512). Outside of this time period, the guests may be prevented from scheduling adjustments, for example in the manner set forth in FIG. 19. The thermostats 46 may, in some embodiments, also learn from the guest's settings adjustments to auto-schedule settings adjustments for the duration of the guest's stay.

When the guest has a similar system (i.e., a thermostat system that is serviced by the same provider of the cloud-based computing system 64), the method 500 may also include enabling the guest's home system to be updated with vacation settings that are tied to adjustments made at the vacation locale for future use. The guest's home system may also learn from the adjustments made by the guest at the vacation locale in order to appropriately auto-adjust settings when the guest's home location experiences conditions that are similar to those of the vacation locale. For example, if the vacation locale is in a sub-tropical climate, the guest's home system may learn from the guest's adjustments and make similar adjustments to the guest's home system when the home location's weather is hot and humid. Indeed, any number of learning modes may be established based on the guest's adjustments while on vacation.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

What is claimed is:

1. A method for thermostatically controlling a heating, ventilation, or air conditioning (HVAC) system in a home, the method comprising:
via a thermostat system configured to effect control over the HVAC system:
receiving a guest input indicative of the presence of a guest user;
determining a level of access of the guest user based at least on an input from a primary user, the level of access determining the guest user's ability to adjust a setting of the HVAC system via the thermostat system; and
initiating a guest mode of operation where the guest user is able to make a setting adjustment to the HVAC system in place of an established setting adjustment schedule of the primary user in accordance with the determined level of access.

2. The method of claim 1, comprising, via the thermostat system, initiating a guest learning mode in which the thermostat system learns from setting adjustments made by the guest user to establish a guest setting adjustment schedule specific to the guest user, the guest setting adjustment schedule comprising a series of setting adjustments to be made to the HVAC system according to a time schedule.

3. The method of claim 2, wherein the guest learning mode is initiated for only a subset of thermostats of the thermostat system such that the guest user has a greater level of control over an effect of the HVAC system on one area of the home versus another area of the home.

4. The method of claim 1, comprising suspending or terminating a primary user learning mode upon initiation of the guest mode of operation, wherein the primary user learning mode comprises learning from setting adjustments made by the primary user to update or modify the established setting adjustment schedule.

5. The method of claim 1, wherein determining the level of access of the guest user based at least on the input from the primary user comprises:
identifying the guest user; and
comparing an identity of the guest user to a set of preferences of the primary user stored in the thermostat system, wherein the set of preferences comprises guest identities associated with respective predetermined levels of access.

6. The method of claim 1, wherein determining the level of access of the guest user based at least on the input from the primary user comprises:
identifying the guest user; and
prompting the primary user to associate the identified guest user with available settings adjustments for the HVAC system that establishes the level of access for the guest user.

7. The method of claim 1, wherein determining the level of access of the guest user based at least on the input from the primary user comprises identifying the guest user based on data received via a smart vehicle of the guest user, based on a gait analysis of the guest user, based on a smartphone signature of the guest user, based on profile data received via a personal wireless electronic device of the guest user, based on an input code associated with the guest user, or any combination thereof.

8. The method of claim 7, wherein the profile data received via the personal wireless electronic device of the guest user comprises home or visitation settings of the guest user provided via a mobile application on the personal wireless electronic device of the guest user, the home settings of the guest user comprising predefined temperature settings associated with the guest user's home and the visitation settings comprising a desired temperature predefined by the guest user for use when the guest user is away from home.

9. The method of claim 8, comprising, via the thermostat system:
importing the home or visitation settings of the guest user; and
implementing at least a portion of the home or visitation settings of the guest user in place of at least a portion of the established setting adjustment schedule, wherein implementing at least the portion of the home or visitation settings of the guest user comprises using a thermal profile established for the home generated by the primary user's use of the thermostat system.

10. The method of claim 7, wherein the profile data received via the personal wireless electronic device of the guest user comprises a scanned code generated by a mobile thermostat system control application on the personal wireless electronic device of the guest user.

11. The method of claim 1, wherein receiving the guest input indicative of the presence of the guest user comprises:
receiving a request for the setting adjustment to the HVAC system; and
determining whether the request is indicative of the guest user based on a comparison of the request to the established setting adjustment schedule of the primary user and past settings adjustments made on a periodic basis.

12. One or more tangible, non-transitory machine-readable media comprising instructions configured to be carried out on a thermostat system that controls a heating, ventilation, or air conditioning (HVAC) system, the instructions configured to:
receive a guest input indicative of the presence of a guest user;
determine a level of access of the guest user based at least on an input from a primary user, the level of access determining the guest user's ability to adjust a setting of the HVAC system via the thermostat system; and
initiate a guest mode of operation where the guest user is able to make a setting adjustment to the HVAC system in place of an established setting adjustment schedule of the primary user in accordance with the determined level of access.

13. The media of claim 12, wherein the instructions are configured to initiate a guest learning mode in which the thermostat system learns from setting adjustments made by the guest user to establish a guest setting adjustment schedule specific to the guest user, the guest setting adjustment schedule comprising a series of setting adjustments to be made to the HVAC system according to a time schedule.

14. The media of claim 13, wherein the guest learning mode is initiated for only a subset of thermostats of the thermostat system such that the guest user has a greater level of control over an effect of the HVAC system on one area of the home versus another area of the home.

15. The media of claim 12, wherein the instructions are configured to suspend or terminate a primary user learning mode upon initiation of the guest mode of operation, wherein the primary user learning mode comprises learning from setting adjustments made by the primary user to update or modify the established setting adjustment schedule.

16. The media of claim 12, wherein the instructions are configured to determine the level of access of the guest user based at least on the input from the primary user by:
identifying the guest user; and
comparing an identity of the guest user to a set of preferences of the primary user stored in the thermostat system, wherein the set of preferences comprises guest identities associated with respective predetermined levels of access.

17. The media of claim 12, wherein the instructions are configured to determine the level of access of the guest user based at least on the input from the primary user by:
identifying the guest user; and
prompting the primary user to associate the identified guest user with available settings adjustments for the HVAC system that establishes the level of access for the guest user.

18. The media of claim 12, wherein the instructions are configured to determine the level of access of the guest user based at least on the input from the primary user by identifying the guest user based on data received via a smart vehicle of the guest user, based on a gait analysis of the guest user, based on a smartphone signature of the guest user, based on profile data received via a personal wireless electronic device of the guest user, based on an input code associated with the guest user, or any combination thereof.

19. The media of claim 12, wherein the instructions are configured to:
import home or visitation settings of the guest user; and
implement at least a portion of the home or visitation settings of the guest user in place of at least a portion of the established setting adjustment schedule, wherein the instructions are configured to implement at least the portion of the home or visitation settings of the guest user using a thermal profile established for the home generated by the primary user's use of the thermostat system.

20. The media of claim 12, wherein the instructions are configured to receive the guest input indicative of the presence of the guest user by:
receiving a request for the setting adjustment to the HVAC system; and
determining whether the request is indicative of the guest user based on a comparison of the request to the established setting adjustment schedule of the primary user and past settings adjustments made on a periodic basis.

21. A system configured to control a heating, ventilation, or air conditioning (HVAC) system, the system comprising:
an electronic device, comprising:
a user input interface configured to receive a guest input from a guest user, the guest input comprising identifying information relating to the guest user; and
a processor configured to determine a level of access of the guest user based on the identifying information and on an input from a primary user, wherein the level of access of the guest user determines the guest user's ability to adjust a setting of the HVAC system via the electronic device, and wherein the processor is configured to initiate a guest mode of operation where the guest user is able to make a setting adjustment to the HVAC system via the electronic device in place of an established setting adjustment schedule of the primary user in accordance with the determined level of access.

22. The system of claim 21, wherein the processor is configured to initiate a guest learning mode in which the thermostat system learns from setting adjustments made by the guest user to establish a guest setting adjustment schedule specific to the guest user, the guest setting adjustment schedule comprising a series of setting adjustments to be made to the HVAC system according to a time schedule.

23. The system of claim 22, wherein the system comprises a plurality of the electronic devices, and wherein the processors of only a subset of the electronic devices of the system are configured to initiate the guest learning mode such that the guest user has a greater level of control over an effect of the HVAC system on one area of the home versus another area of the home.

24. The system of claim 21, wherein the processor is configured to suspend or terminate a primary user learning mode upon initiation of the guest mode of operation, wherein the primary user learning mode comprises learning from setting adjustments made by the primary user to update or modify the established setting adjustment schedule.

25. The system of claim 21, wherein the processor is configured to determine the level of access of the guest user by comparing identifying information of the guest user to a set of preferences of the primary user stored in the system, wherein the set of preferences comprises guest identities associated with respective predetermined levels of access.

26. The system of claim 21, wherein the processor is configured to determine the level of access of the guest user by prompting the primary user to associate the identified guest user with available settings adjustments for the HVAC system that establishes the level of access for the guest user.

27. The system of claim 21, wherein the user input interface is configured to receive the identifying information from via a smart vehicle of the guest user, from on a gait analysis of the guest user, from on a smartphone signature of the guest user, from profile data received via a personal wireless electronic device of the guest user, from an input code associated with the guest user, or any combination thereof.

28. The system of claim 21, wherein the processor is configured to import home or visitation settings of the guest user, and implement at least a portion of the home or visitation settings of the guest user in place of at least a portion of the established setting adjustment schedule, and wherein the processor is configured to implement at least the portion of the home or visitation settings of the guest user using a thermal profile established for the home generated by the primary user's use of the system.

29. The system of claim 21, wherein the processor is configured to determine whether a request for a settings adjustment to the HVAC system via the electronic device is indicative of the presence of the guest user based on a comparison of the request to the established setting adjustment schedule of the primary user and past settings adjustments made on a periodic basis.
